(19) United States
(12) Patent Application Publication
(10) Pub. No.: US 2019/0316923 A1
(43) Pub. Date: Oct. 17, 2019

(54) INFORMATION PROCESSING APPARATUS AND METHOD

(71) Applicant: FUJITSU LIMITED, Kawasaki-shi (JP)

(72) Inventors: Toshiaki Ando, Yokohama (JP); Takushi Fujita, Chigasaki (JP)

(73) Assignee: FUJITSU LIMITED, Kawasaki-shi (JP)

(21) Appl. No.: 16/451,851

(22) Filed: Jun. 25, 2019

Related U.S. Application Data
(63) Continuation of application No. PCT/JP2016/089043, filed on Dec. 28, 2016.

(51) Int. Cl. G01C 21/34; G01C 21/36

(52) U.S. Cl. CPC G01C 21/3461; G01C 21/3691; G01C 21/3605; G01C 21/3415

(57) ABSTRACT

An information processing apparatus includes: a memory; and a processor coupled to the memory and configured to: refer to first information that indicates a traveling locus of a vehicle and second information that indicates a risk latent in an area; count a distance which is traveled by the vehicle along a route included in the area and a number of times of unsafe driving movements which are taken by the vehicle while traveling on the route; calculate risk tolerance of a driver against the risk on the basis of the counted distance and number of times; and correct a passage cost between two points on a route using the risk and the risk tolerance.

### CROSS-REFERENCE TO RELATED APPLICATION

This application is a continuation application of International Application PCT/JP2016/089043 filed on Dec. 28, 2016 and designated the U.S., the entire contents of which are incorporated herein by reference.

### FIELD

The embodiments discussed herein are related to an information processing apparatus and a route information providing method.

### BACKGROUND

A recommended route from a departure point of a vehicle to a destination is searched for and route information on the recommended route is presented to a driver.[0003] Japanese Laid-open Patent Publication No. 2008-175571 is disclosed as related art.

### SUMMARY

According to an aspect of the embodiments, an information processing apparatus includes: a memory; and a processor coupled to the memory and configured to: refer to first information that indicates a traveling locus of a vehicle and second information that indicates a risk latent in an area; count a distance which is traveled by the vehicle along a route included in the area and a number of times of unsafe driving movements which are taken by the vehicle while traveling on the route; calculate risk tolerance of a driver against the risk on the basis of the counted distance and number of times; and correct a passage cost between two points on a route using the risk and the risk tolerance.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an example of a route information providing system according to a first embodiment;

FIG. 2 is an example of a hardware configuration of an in-vehicle device;

FIG. 3 is an example of a functional block diagram of the in-vehicle device;

FIG. 4 is an example of a traveling locus storage part;

FIG. 5 is an example of a functional block diagram of a regional risk updating part;

FIG. 6 is a diagram for explaining conversion of meteorological data to regional risk information;

FIG. 7 is a diagram for explaining conversion of traffic data to the regional risk information;

FIG. 8 is a diagram for explaining conversion of population distribution data to the regional risk information;

FIG. 9 is an example of a regional risk storage part;

FIG. 10 is an example of area information;

FIGS. 11A and 11B are diagrams for explaining overlapping of occurrence positions of unsafe driving movements and risk areas;

FIG. 12 is an example of a risk tolerance storage part;

FIG. 13A is an example of link information acquired by a cost correcting part; FIG. 13B is a diagram illustrating link relationships between respective nodes specified on the basis of the link information;

FIG. 14 is a diagram for explaining an example of correction of a standard cost according to a working example;

FIG. 15 is an example of generation of route information according to a first comparative example;

FIG. 16 is an example of generation of route information according to a second comparative example;

FIG. 17 is a flowchart illustrating an example of the action of the in-vehicle device;

FIG. 18 is a flowchart illustrating another example of the action of the in-vehicle device;

FIG. 19 is a flowchart illustrating another example of the action of the in-vehicle device;

FIG. 20 is a functional block diagram of an in-vehicle device according to a second embodiment;

FIG. 21 is a functional block diagram of an in-vehicle device according to a third embodiment;

FIG. 22 is a graph illustrating the relationship between elapsed time and risk tolerance;

FIG. 23 is a functional block diagram of an in-vehicle device according to a fourth embodiment;

FIG. 24 is an example of an unsafe driving storage part;

FIG. 25 is a functional block diagram of an in-vehicle device according to a fifth embodiment;

FIG. 26 is an example of a route information providing system according to a sixth embodiment;

FIG. 27 is an example of a hardware configuration of a risk management server;

FIG. 28 is an example of a functional block diagram of the risk management server;

FIG. 29 is a functional block diagram of an in-vehicle device according to the sixth embodiment;

FIG. 30 is an example of a route information providing system according to a seventh embodiment;

FIG. 31 is an example of a functional block diagram of a risk tolerance management server; and

FIG. 32 is a functional block diagram of an in-vehicle device according to the seventh embodiment.

### DESCRIPTION OF EMBODIMENTS

For example, a search for a recommended route is concluded, for example, depending on the shortness of the travel distance and the travel time. For example, when the recommended route has a plurality of candidates, a candidate having the lowest degree of danger with respect to the behavior of the vehicle is designated as the recommended route.

Hereinafter, modes for carrying out the present invention will be described with reference to the drawings.

### First Embodiment

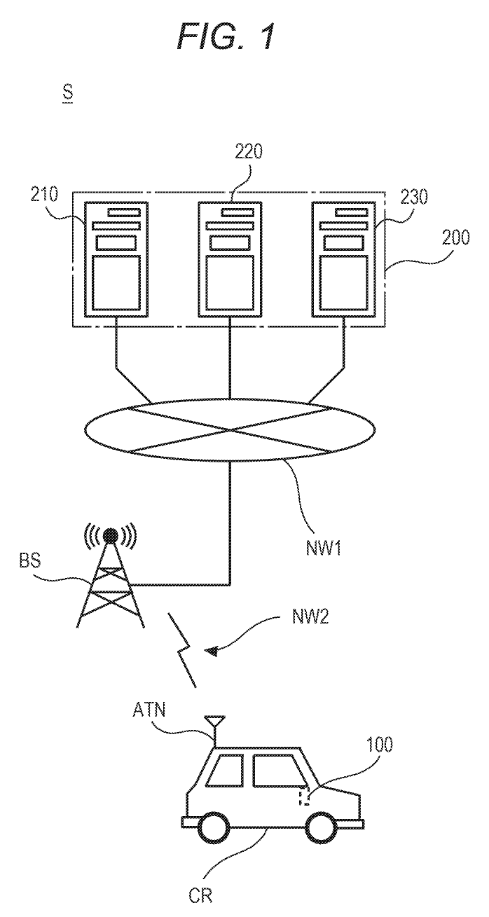

FIG. 1 is an example of a route information providing system S according to a first embodiment. The route information providing system S is a computer system that provides a driver of a vehicle CR with route information in consideration of various risks latent on a travel route from a departure point to a destination and the tolerance of the driver against the latent risks. The route information providing system S includes an in-vehicle device 100 as a route searching apparatus and an information providing server 200. The in-vehicle device 100 is mounted on the vehicle CR. An electronic device such as a car navigation system is used for the in-vehicle device 100. For example, a smart device such as a smartphone or a tablet terminal may be used as the in-vehicle device 100.

The information providing server 200 provides data representing specific information for each type of information. The information providing server 200 includes a plurality of servers such as a meteorological information server 210, a traffic information server 220, and a population information server 230. The information providing server 200 is only supposed to include at least one of the meteorological information server 210, the traffic information server 220, and the population information server 230.

The meteorological information server 210 collects various kinds of information relating to the meteorology from, for example, rain gauges installed in different places and meteorological satellites to accumulate, and provides meteorological data representing precipitation amount, snowfall amount, and the like. The traffic information server 220 calculates and accumulates the congestion situation of a road on the basis of the number of vehicles obtained from a vehicle sensor installed on the road or the like and probe information sent by the vehicle CR and the like, and provides traffic data representing a traffic volume. For example, the population information server 230 collects and accumulates population data owned by each local government and provides population density data representing the population density.

The in-vehicle device 100 and the information providing server 200 are connected by a communication network such as a wired network NW1 and a wireless network NW2. Therefore, once the information providing server 200 provides various kinds of data, the in-vehicle device 100 may receive various types of data by way of the wired network NW1, a mobile base station BS, the wireless network NW2, and an antenna ATN. The in-vehicle device 100 displays route information from a departure point to a destination using received data, data representing the state of the vehicle CR (for example, vehicle speed and acceleration), data input from the driver of the vehicle CR, and the like.

Hereinafter, details of the in-vehicle device 100 will be described.

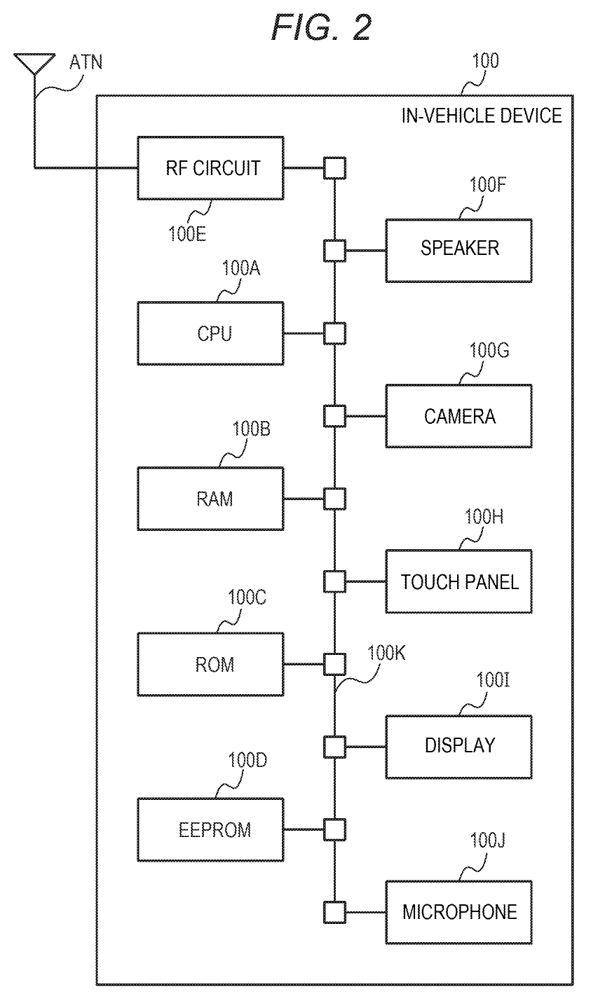

FIG. 2 is an example of a hardware configuration of the in-vehicle device 100. As illustrated in FIG. 2, the in-vehicle device 100 includes a central processing unit (CPU) 100A, a random access memory (RAM) 100B, a read only memory (ROM) 100C, an electrically erasable programmable read only memory (EEPROM) 100D, and a radio frequency (RF) circuit 100E. The antenna ATN is connected to the RF circuit 100E. Instead of the RF circuit 100E, a CPU that implements a communication function may be used.

The in-vehicle device 100 also includes a speaker 100F, a camera 100G, a touch panel 100H, a display 100I, and a microphone 100J. The CPU 100A to the microphone 100J are connected to each other by an internal bus 100K. At least the CPU 100A and the RAM 100B cooperate to implement a computer.

Programs stored in the ROM 100C and the EEPROM 100D are saved in the RAM 100B described above by the CPU 100A. By executing the saved programs by the CPU 100A, various functions to be described later are implemented and various processes are executed. The programs are only supposed to be in accordance with flowcharts to be described later.

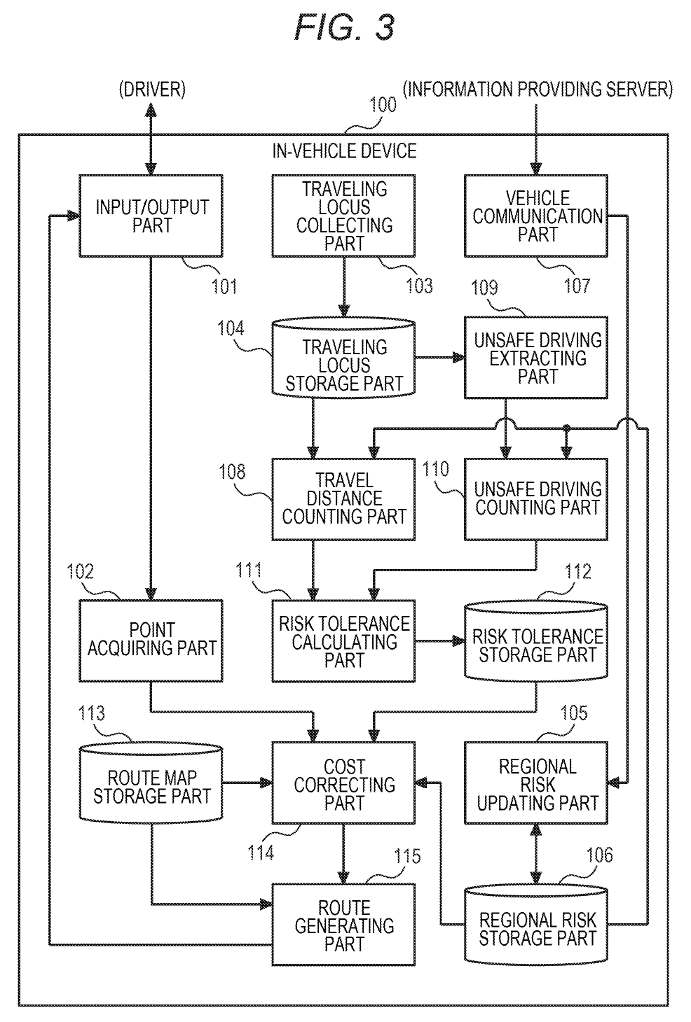

FIG. 3 is an example of a functional block diagram of the in-vehicle device 100. The in-vehicle device 100 includes an input/output part 101 and a point acquiring part 102. The in-vehicle device 100 also includes a traveling locus collecting part 103 and a traveling locus storage part 104. The in-vehicle device 100 further includes a regional risk updating part 105, a regional risk storage part 106, and a vehicle communication part 107. In addition, the in-vehicle device 100 includes a travel distance counting part 108, an unsafe driving extracting part 109, and an unsafe driving counting part 110. The in-vehicle device 100 includes a risk tolerance calculating part 111 and a risk tolerance storage part 112. The in-vehicle device 100 includes a route map storage part 113, a cost correcting part 114, and a route generating part 115.

The above-mentioned input/output part 101 is implemented, for example, by the touch panel 100H and the display 100I. The point acquiring part 102, the traveling locus collecting part 103, the regional risk updating part 105, the travel distance counting part 108, the unsafe driving extracting part 109, the unsafe driving counting part 110, the risk tolerance calculating part 111, the cost correcting part 114, and the route generating part 115 mentioned above are implemented, for example, by the CPU 100A. The traveling locus storage part 104, the regional risk storage part 106, the risk tolerance storage part 112, and the route map storage part 113 mentioned above are implemented, for example, by the RAM 100B or the EEPROM 100D. The vehicle communication part 107 mentioned above is implemented, for example, by the RF circuit 100E and the antenna ATN.

The input/output part 101 accepts various types of data on the basis of an input operation by the driver to hold. For example, the input/output part 101 accepts and holds not only data representing the departure point and the destination, but also data representing the priority or the like of the travel route, such as whether the expressway is to be used. Furthermore, the input/output part 101 outputs route information. In more detail, the input/output part 101 displays route information representing a travel route from the departure point to the destination. With this function, the driver is allowed to visually recognize the travel route. The input/output part 101 may acquire the current position using a global positioning system (GPS) function to set the acquired current position as the departure point.

The point acquiring part 102 acquires the departure point and the destination from the input/output part 101. Upon acquiring the departure point and the destination, the point acquiring part 102 transmits the acquired departure point and destination to the cost correcting part 114.

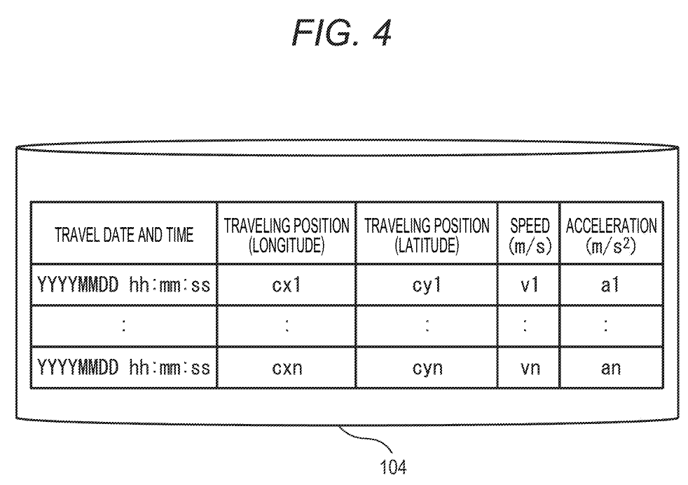

The traveling locus collecting part 103 collects the traveling locus of the vehicle CR. For example, the traveling locus collecting part 103 collects the current time and the traveling position (for example, longitude and latitude) at that time using the GPS function. The traveling locus collecting part 103 also collects the speed and acceleration of the vehicle CR at the current time from a speed sensor and an acceleration sensor attached to the engine or the like of the vehicle CR. The traveling locus collecting part 103 associates the current time, traveling position, speed, and acceleration with each other to save in the traveling locus storage part 104 as traveling locus information. With this procedure, the traveling locus storage part 104 stores the traveling locus information as illustrated in FIG. 4.

For example, an in-vehicle camera may be attached in the interior of the vehicle CR to photograph the driver such that the result of inferring the behavior of the driver (for example, dozing or looking aside) is included in the traveling locus information. In addition, biometric information (for example, pulse and blood pressure) of the driver may be acquired using a biometric sensor such that the health condition of the driver obtained from the acquired biometric information is included in the traveling locus information.

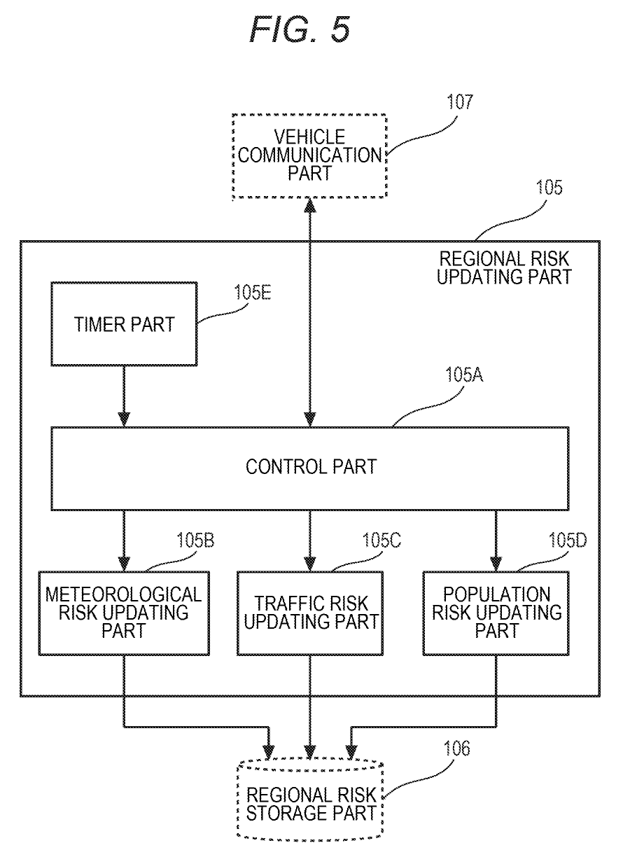

The regional risk updating part 105 periodically or non-periodically updates the regional risk storage part 106. As illustrated in FIG. 5, the regional risk updating part 105 includes a control part 105A, a meteorological risk updating part 105B, a traffic risk updating part 105C, a population risk updating part 105D, and a timer part 105E. The timer part 105E has a clock function and a calendar function.

The control part 105A controls actions of the meteorological risk updating part 105B, the traffic risk updating part 105C, and the population risk updating part 105D. For example, the control part 105A periodically confirms the timer part 105E to control the update cycle (update period) of each of the meteorological risk updating part 105B, the traffic risk updating part 105C, and the population risk updating part 105D. For example, the control part 105A activates the meteorological risk updating part 105B in a cycle of several minutes (for example, one minute). The control part 105A activates the traffic risk updating part 105C in a cycle of several tens of minutes (for example, ten minutes). The control part 105A activates the population risk updating part 105D in a cycle of several months (for example, one month).

For example, when the control part 105A activates the meteorological risk updating part 105B, the meteorological risk updating part 105B acquires meteorological data including a predetermined weather from the meteorological information server 210 via the vehicle communication part 107. Upon acquiring the meteorological data, the meteorological risk updating part 105B converts the meteorological data into regional risk information and saves the regional risk information in the regional risk storage part 106.

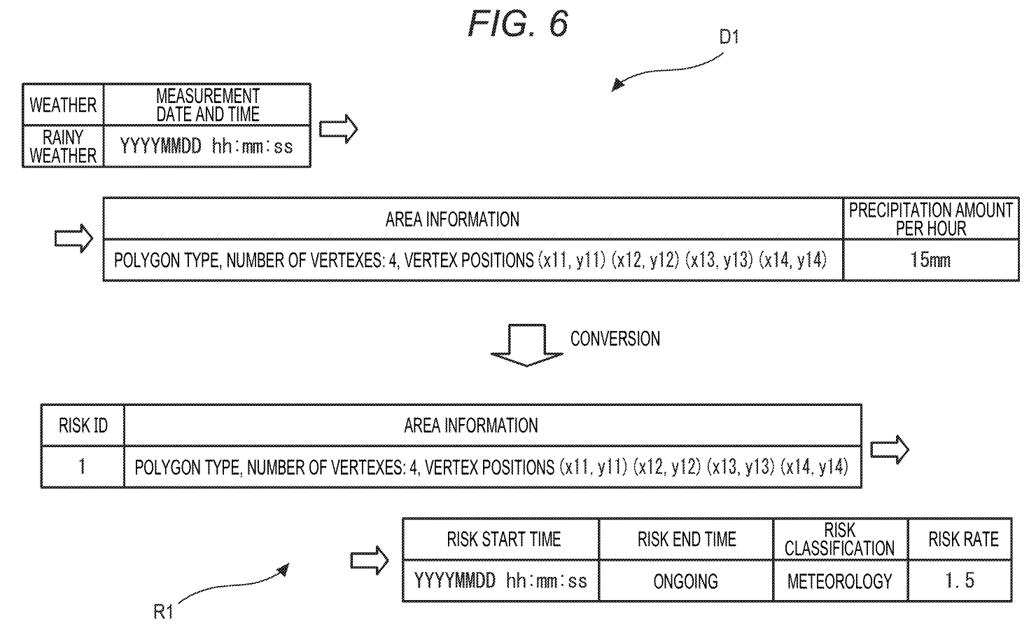

For example, as illustrated in FIG. 6, when acquiring meteorological data D1 including a predetermined weather (for example, a weather “rainy weather”) from among a plurality of pieces of meteorological data each including weather, measurement date and time, area information, and precipitation amount per hour, the meteorological risk updating part 105B generates a risk ID that identifies the regional risk information and calculates a risk rate. The risk rate relating to the meteorology is calculated from a precipitation amount per hour divided by a predetermined reference rate. In the first embodiment, for example, by adopting a reference rate “10 mm”, the meteorological risk updating part 105B calculates a risk rate “1.5”. Upon calculating the risk rate, the meteorological risk updating part 105B saves, in the regional risk storage part 106, regional risk information R1 including the generated risk ID (for example, a risk ID “1”), risk start time and area information that have taken over the measurement date and time and the area information of the meteorological data, respectively, risk end time “ongoing”, a risk classification “meteorology”, and the calculated risk rate.

For example, when the control part 105A activates the traffic risk updating part 105C, the traffic risk updating part 105C acquires traffic data from the traffic information server 220 via the vehicle communication part 107. Upon acquiring the traffic data, the traffic risk updating part 105C converts the traffic data into regional risk information and saves the regional risk information in the regional risk storage part 106.

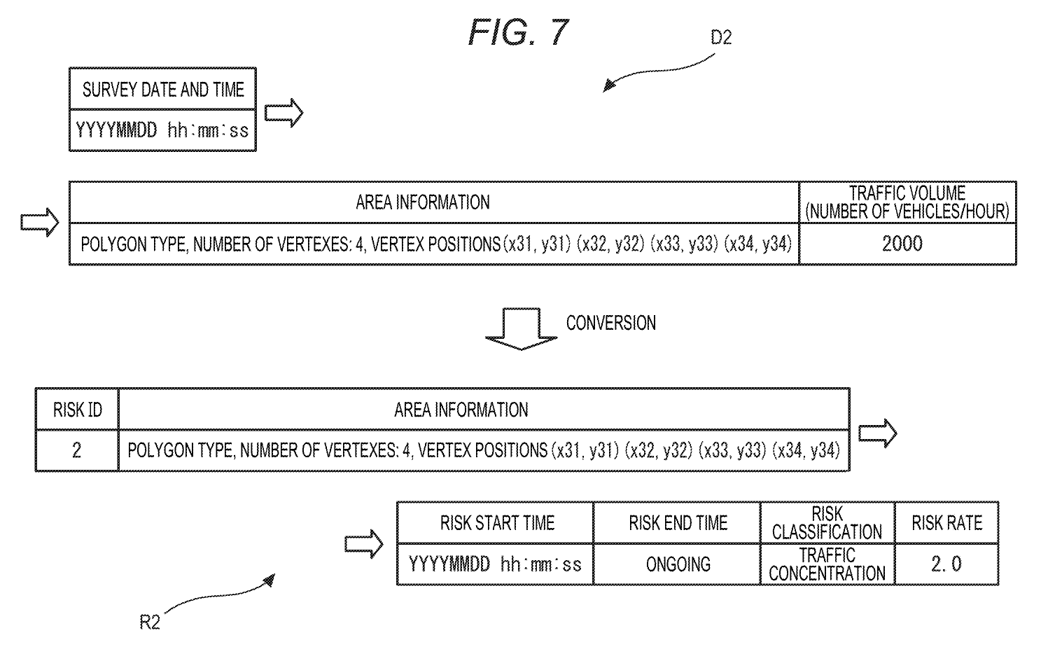

For example, as illustrated in FIG. 7, when acquiring traffic data D2 including survey date and time, area information, and a traffic volume (number of vehicles per hour), the traffic risk updating part 105C generates a risk ID and calculates a risk rate. The risk rate relating to the traffic is calculated from a traffic volume divided by a predetermined reference rate. In the first embodiment, for example, by adopting a reference rate “1000 vehicles/hour”, the traffic risk updating part 105C calculates a risk rate “2.0”. Upon calculating the risk rate, the traffic risk updating part 105C saves, in the regional risk storage part 106, regional risk information R2 including the generated risk ID (for example, a risk ID “2”), risk start time and area information that have taken over the survey date and time and the area information of the traffic data, respectively, risk end time “ongoing”, a risk classification “traffic concentration”, and the calculated risk rate.

For example, when the control part 105A activates the population risk updating part 105D, the population risk updating part 105D acquires population density data from the population information server 230 via the vehicle communication part 107. Upon acquiring the population density data, the population risk updating part 105D converts the population density data into regional risk information and saves the regional risk information in the regional risk storage part 106.

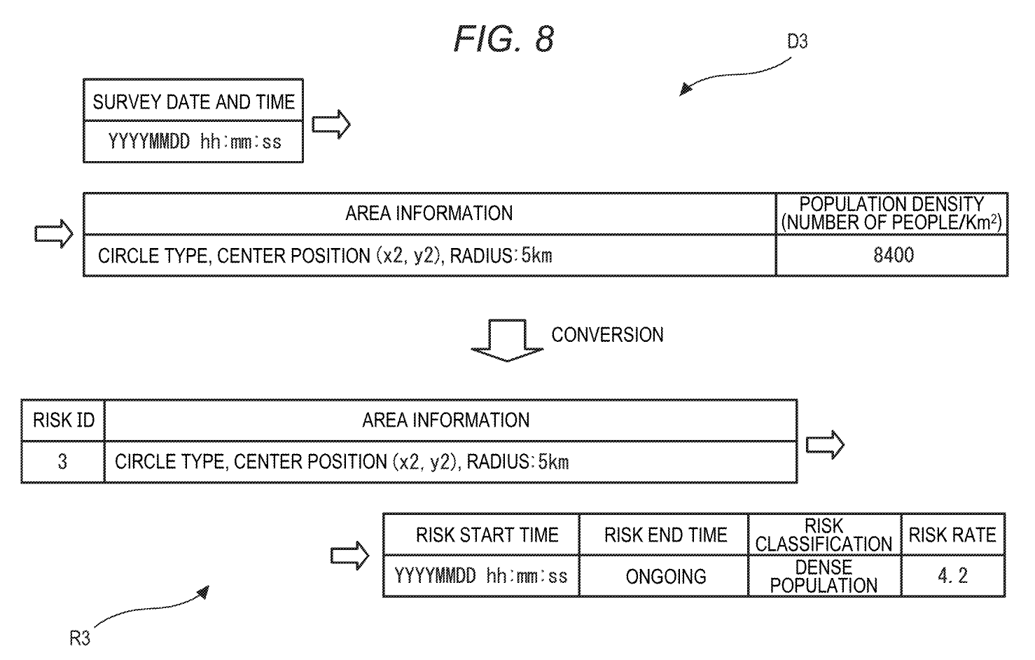

For example, as illustrated in FIG. 8, when acquiring population density data D3 including survey date and time, area information, and population density (the number of people per 1 km²), the population risk updating part 105D generates a risk ID and calculates a risk rate. Here, the risk rate relating to the population density is calculated from the number of people per 1 km² divided by a predetermined reference rate. In the first embodiment, for example, by adopting a reference rate “2000 people/km²”, the population risk updating part 105D calculates a risk rate “4.2”. Upon calculating the risk rate, the population risk updating part 105D saves, in the regional risk storage part 106, regional risk information R3 including the generated risk ID (for example, a risk ID “3”), risk start time and area information that have taken over the survey date and time and the area information of the population density data, respectively, risk end time “ongoing”, a risk classification “dense population”, and the calculated risk rate.

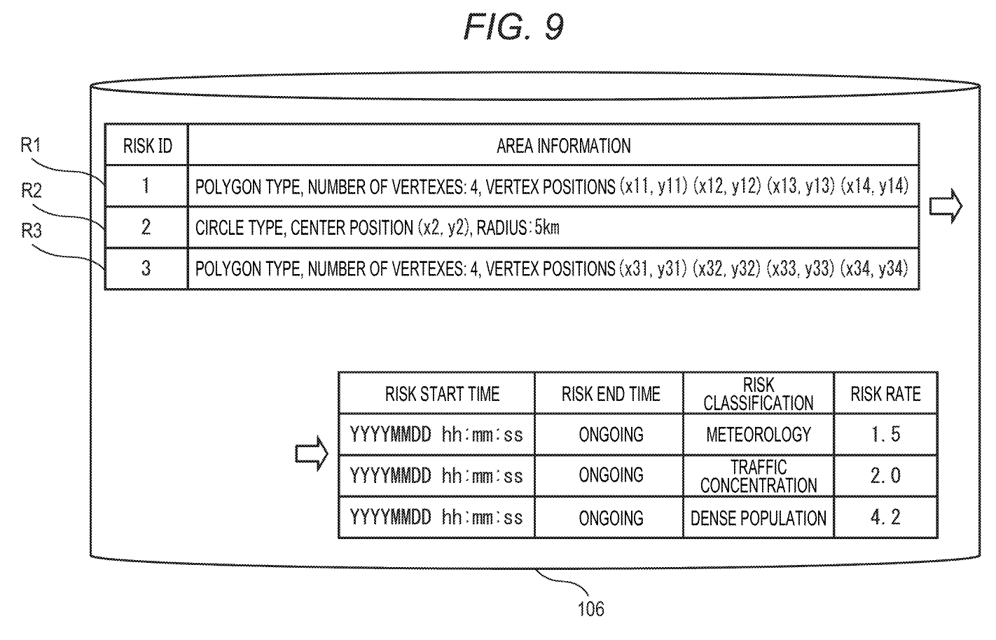

As described above, the meteorological risk updating part 105B, the traffic risk updating part 105C, and the population risk updating part 105D save the regional risk information R1 including the risk classification “meteorology”, the regional risk information R2 including the risk classification “traffic concentration”, and the regional risk information R3 including the risk classification “dense population” in the regional risk storage part 106, respectively. With this procedure, the regional risk storage part 106 stores the regional risk information R1, the regional risk information R2, and the regional risk information R3 including various kinds of risk classifications as illustrated in FIG. 9.

When the risk rate calculated by each of the meteorological risk updating part 105B, the traffic risk updating part 105C, and the population risk updating part 105D is equal to or less than a predetermined threshold value (for example, a threshold value “1.0”), the meteorological risk updating part 105B, the traffic risk updating part 105C, and the population risk updating part 105D each infer that there is no risk with respect to the relevant risk classification and stop saving the regional risk information including the relevant risk rate in the regional risk storage part 106.

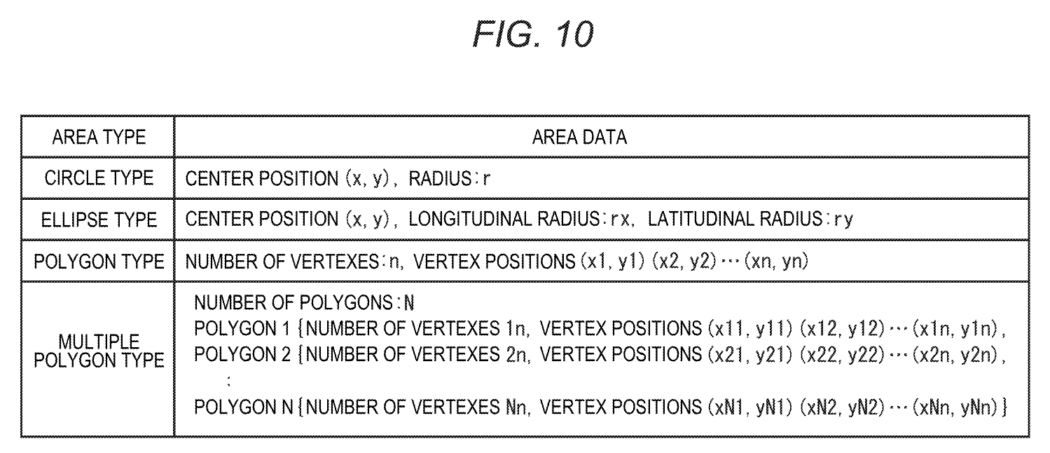

The above-described area information will be described here in detail with reference to FIG. 10. FIG. 10 is an example of the area information. As illustrated in FIG. 10, the area information includes an area type and area data as constituent elements. The area information is information that specifies an area. For example, if the area type is “circle type”, the area of this type is specified by a center position (x, y) specified by longitude and latitude and a radius r. The remaining area types are basically similar to the area type “circle type”. An area type “polygon type” represents a polygonal area in which all the interior angles are less than 180 degrees. For example, when one of the interior angles of the polygonal area exceeds 180 degrees, the area of this case is specified by being divided into a plurality of polygons.

Returning to FIG. 3, the travel distance counting part 108 counts the travel distance of a travel route with a latent risk for each risk classification and the travel distance of a travel route without latent risk. For example, the travel distance counting part 108 acquires the traveling locus information from the traveling locus storage part 104. In addition, the travel distance counting part 108 acquires the regional risk information from the regional risk storage part 106. On the basis of the acquired traveling locus information and regional risk information, the travel distance counting part 108 counts a travel distance traveled in an area with a latent risk (hereinafter referred to as risk area), for each risk classification and also counts a travel distance traveled in an area without latent risk (hereinafter referred to as non-risk area). The travel distance counting part 108 transmits each counted travel distance to the risk tolerance calculating part 111.

The unsafe driving extracting part 109 acquires the traveling locus information from the traveling locus storage part 104 and extracts an unsafe driving movement of the driver, such as a near-accident and a position where the extracted driving movement occurred. For example, when detecting an acceleration smaller than −0.5G on the basis of the acquired traveling locus information, the unsafe driving extracting part 109 extracts an unsafe driving movement such as sudden braking and also extracts a position where the extracted driving movement (for example, sudden braking) occurred. Conversely, when detecting an acceleration greater than 0.5G on the basis of the acquired traveling locus information, the unsafe driving extracting part 109 extracts an unsafe driving movement such as sudden start and extracts a position where the extracted driving movement (for example, sudden start) occurred. Upon extracting the unsafe driving movement and the position where the extracted driving movement occurred, the unsafe driving extracting part 109 transmits the extracted driving movement and position to the unsafe driving counting part 110. If information such as the result of inferring the behavior of the driver and the health condition of the driver is included in the traveling locus information, the unsafe driving extracting part 109 may extract the unsafe driving movement of the driver and the position where the extracted driving movement occurred, on the basis of these types of information.

The unsafe driving counting part 110 counts the number of times the driver has taken unsafe driving movements. In more detail, when the driving movement and the position are transmitted from the unsafe driving extracting part 109, the unsafe driving counting part 110 acquires the regional risk information from the regional risk storage part 106. On the basis of the transmitted driving movement and position and the regional risk information acquired from the regional risk storage part 106, the unsafe driving counting part 110 counts the number of times the unsafe driving movements have been taken, for each risk classification and also counts the number of times the unsafe driving movements have been taken on a travel route in the non-risk area. Upon counting the number of times the unsafe driving movements have been taken, the unsafe driving counting part 110 transmits the counted number of times to the risk tolerance calculating part 111. In this example, the unsafe driving counting part 110 counts the number of times the unsafe driving movements have been taken; however, for example, if the unsafe driving extracting part 109 not only extracts the unsafe driving movement, but also classifies this unsafe driving movement into levels according to the degree of unsafeness, the unsafe driving counting part 110 may perform counting by level. For example, sudden braking is classified into a level smaller than −1.0G and a level from −0.5G to −1.0G. Alternatively, a method of counting by multiplying the number of times by the level may be employed.

The risk tolerance calculating part 111 calculates a risk tolerance score on the basis of the travel distance transmitted from the travel distance counting part 108 and the number of times transmitted from the unsafe driving counting part 110. The risk tolerance score is a numerical value obtained by quantifying the tolerance of the driver against risk.

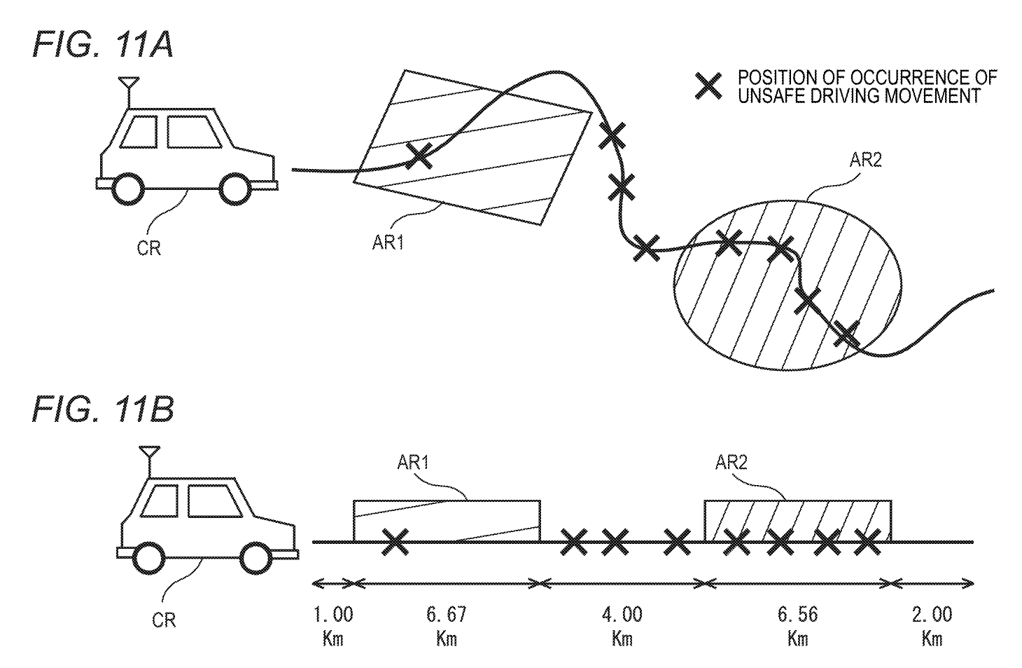

For example, the risk tolerance calculating part 111 first calculates an unsafe driving movement rate for each risk classification. The unsafe driving movement rate is calculated from the number of times the unsafe driving movements have been taken, to the travel distance. For example, as illustrated in FIGS. 11A and 11B, when the travel distance traveled in a risk area AR1 specified by the regional risk information R1 including the risk classification “meteorology” is 6.67 Km, and the number of times the driver has taken the unsafe driving movements while traveling the risk area AR1 is one, the risk tolerance calculating part 111 calculates about 0.15 (=1 time/6.67 Km) as the unsafe driving movement rate. Similarly, when the travel distance traveled in a risk area AR2 specified by the regional risk information R2 including the risk classification “traffic concentration” is 6.56 Km, and the number of times the driver has taken the unsafe driving movements while traveling the risk area AR2 is four, the risk tolerance calculating part 111 calculates about 0.61 (=four times/6.56 Km) as the unsafe driving movement rate. Furthermore, when the travel distance on a travel route obtained by removing a travel route traveled in the risk areas AR1 and AR2 from the travel route from the departure point to the destination is 7.00 Km (=1.00 Km+4.00 Km+2.00 Km), and the number of times the driver has taken the unsafe driving movements while traveling on this travel route is three, the risk tolerance calculating part 111 calculates about 0.43 (=three times/7.00 Km) as the unsafe driving movement rate.

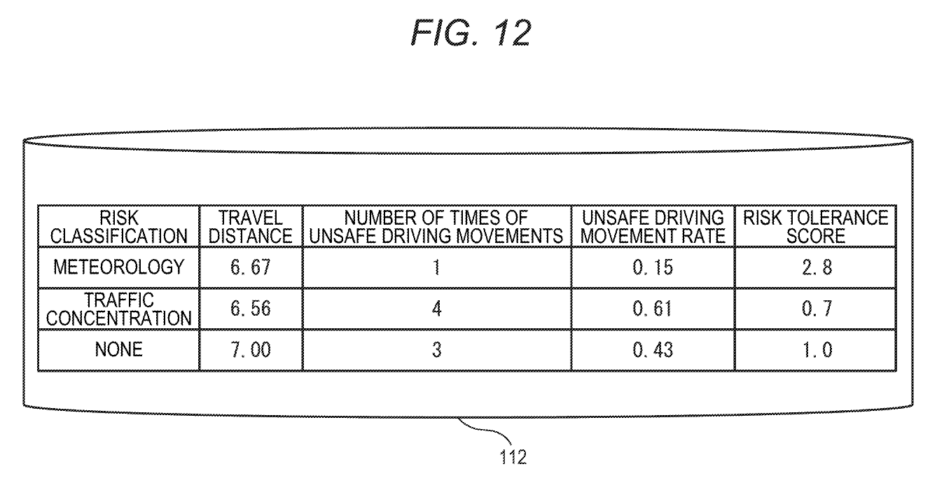

Next, the risk tolerance calculating part 111 calculates the risk tolerance score one by one on the basis of each calculated unsafe driving movement rate. The risk tolerance score is calculated from the unsafe driving movement rate without risk to the unsafe driving movement rate of each latent risk. For example, as described above, when the unsafe driving movement rate of the risk classification “weather” is 0.15 and the unsafe driving movement rate in the case of no risk is 0.43, the risk tolerance calculating part 111 calculates about 2.8 (=0.43/0.15) as the risk tolerance score. Similarly, when the unsafe driving movement rate of the risk classification “traffic concentration” is 0.61, the risk tolerance calculating part 111 calculates about 0.7 (=0.43/0.61) as the risk tolerance score. Furthermore, since the unsafe driving movement rate in the case of no risk is 0.43, the risk tolerance calculating part 111 calculates 1.0 (=0.43/0.43) as the risk tolerance score. Upon calculating the risk tolerance score, the risk tolerance calculating part 111 saves risk tolerance information including the calculated unsafe driving movement rate and risk tolerance score in the risk tolerance storage part 112. With this procedure, the risk tolerance storage part 112 stores the risk tolerance information as illustrated in FIG. 12.

Returning to FIG. 3, the route map storage part 113 stores route map information made up of a collection of page-basis route map information managed in units of pages. The page-basis route map information includes link information including a standard cost (for example, a length of a roadway and an average moving time) expected for passing between two points on a route, background information, and the like.

The cost correcting part 114 corrects the above-mentioned standard cost. In more detail, upon accepting the departure point and the destination transmitted from the point acquiring part 102, the cost correcting part 114 first acquires the link information from the departure point to the destination from the route map storage part 113 on the basis of the accepted departure point and destination.

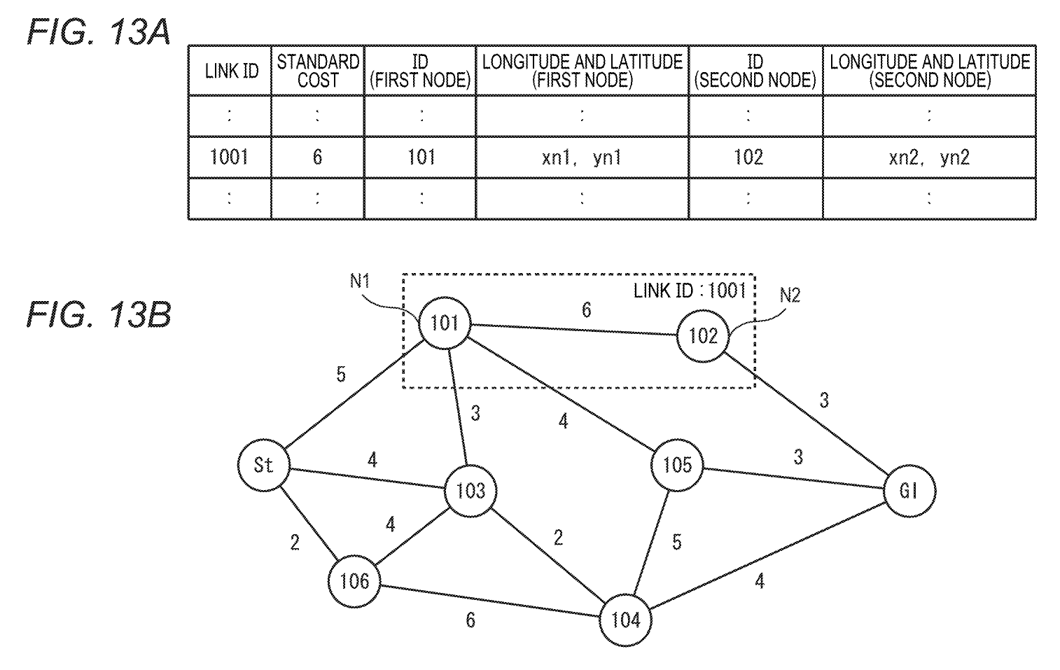

The link information acquired by the cost correcting part 114 will be described here. FIG. 13A is an example of the link information acquired by the cost correcting part 114. FIG. 13B is a diagram illustrating link relationships between respective nodes specified on the basis of the link information. As described above, upon accepting the departure point and the destination, the cost correcting part 114 acquires a plurality of pieces of the link information from the departure point to the destination as illustrated in FIG. 13A. The link information represents, for example, a road section. The link information includes, as constituent elements, a link ID, the standard cost, the ID of a first node, the longitude and latitude of the first node, the ID of a second node, and the longitude and latitude of the second node. The first node and the second node represent two ends of a road section. For example, intersections are used as the first node and the second node. As illustrated in FIGS. 13A and 13B, for example, according to the link information given a link ID “1001”, a node N1 with a node ID “101” located at longitude “xn1” and latitude “yn1” and a node N2 with a node ID “102” located at longitude “xn2” and latitude “yn2” are linked to each other. A standard cost “6” is expected to pass between the nodes N1 and N2.

After acquiring the link information from the departure point to the destination, the cost correcting part 114 further acquires the regional risk information from the regional risk storage part 106 and acquires the risk tolerance information from the risk tolerance storage part 112. Upon acquiring the regional risk information and the risk tolerance information, the cost correcting part 114 corrects the standard cost on the basis of the risk rate in the acquired regional risk information and the risk tolerance score in the acquired risk tolerance information. When having finished correcting the standard cost, the cost correcting part 114 transmits the link information whose standard cost has been corrected to the route generating part 115.

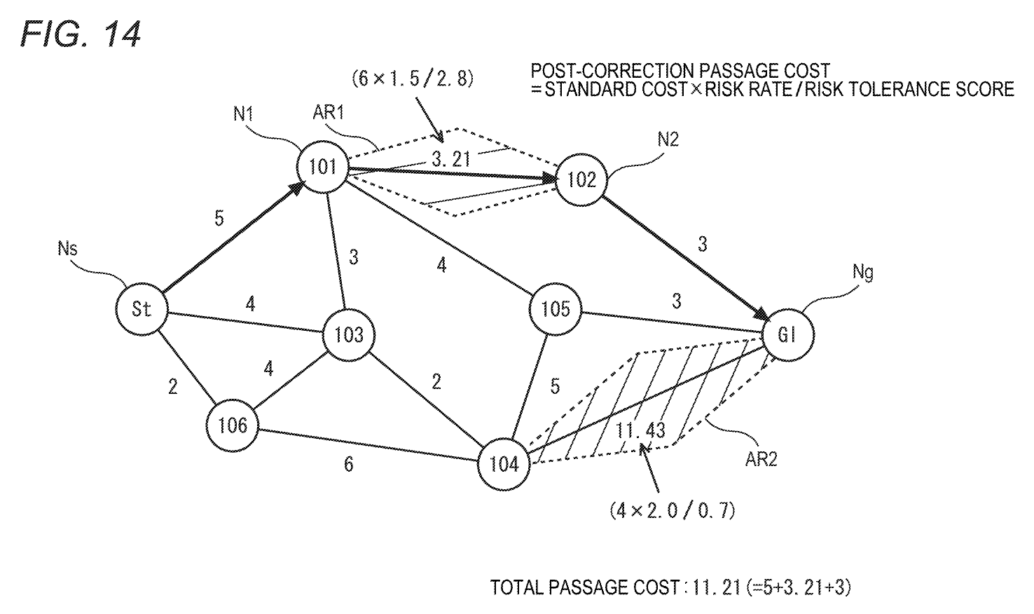

An example of correction of the standard cost according to a working example will be described here with reference to FIG. 14.

FIG. 14 is a diagram for explaining an example of correction of the standard cost according to the working example. For example, as illustrated in FIG. 14, when a travel route specified by the link information with the link ID “1001” is included in the risk area AR1 with a latent risk relating to the meteorology, the cost correcting part 114 calculates a post-correction passage cost on the basis of the standard cost, the risk rate, the risk tolerance score, and a predetermined computation formula. As described above, the standard cost “6” is corrected to the post-correction passage cost “3.21” on the basis of the risk rate “1.5” relating to the meteorology (refer to FIG. 9), the risk tolerance score “2.8” (refer to FIG. 12), and the computation formula.

Likewise, also when a travel route specified by the link information with a link ID (not illustrated) different from the link ID “1001” is included in the risk area AR2 with a latent risk relating to the traffic concentration, the cost correcting part 114 calculates the post-correction passage cost on the basis of the standard cost, the risk rate, the risk tolerance score, and the predetermined computation formula. For example, as illustrated in FIG. 14, the standard cost “4” is corrected to the post-correction passage cost “11.43” on the basis of the risk rate “2.0” relating to the traffic concentration (refer to FIG. 9), the risk tolerance score “0.7” (refer to FIG. 12), and the computation formula.

As described above, even when the risk areas AR1 and AR2 with latent risks are included in the course of the travel route from the departure point to the destination, and a driving load according to the risk rates peculiar to the risk areas AR1 and AR2 are applied to the standard cost, the standard cost is reduced in some cases if the driver has tolerance against the driving load. Conversely, if the driver does not have tolerance against the driving load, the standard cost may increase.

Returning to FIG. 3, upon accepting the corrected link information from the cost correcting part 114, the route generating part 115 generates route information from the departure point to the destination. For example, the route generating part 115 generates route information whose sum value of the cost from the departure point to the destination (hereinafter referred to as total passage cost) is minimized, using the Dijkstra method. As illustrated in FIG. 14, multiple nodes N1, N2, . . . are present from a node Ns with a node ID “St” representing the departure point to a node Ng with a node ID “GI” representing the destination. Accordingly, diverse travel routes may be selected as candidates to reach the destination from the departure point; nevertheless, the route generating part 115 generates route information passing through the nodes Ns, N1, N2, and Ng, in which the minimum value of the total passage cost “11.21” is calculated. Upon generating the route information, the route generating part 115 transmits the generated route information to the input/output part 101. Upon receiving the route information, the input/output part 101 outputs the received route information.

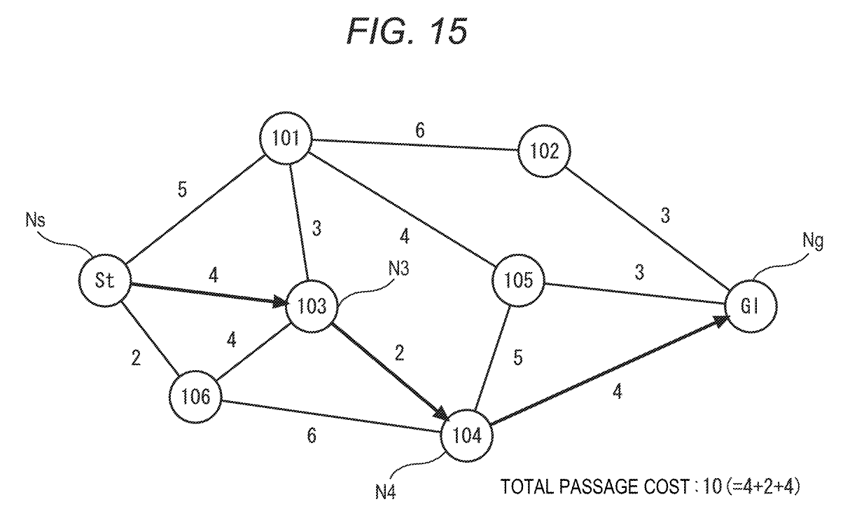

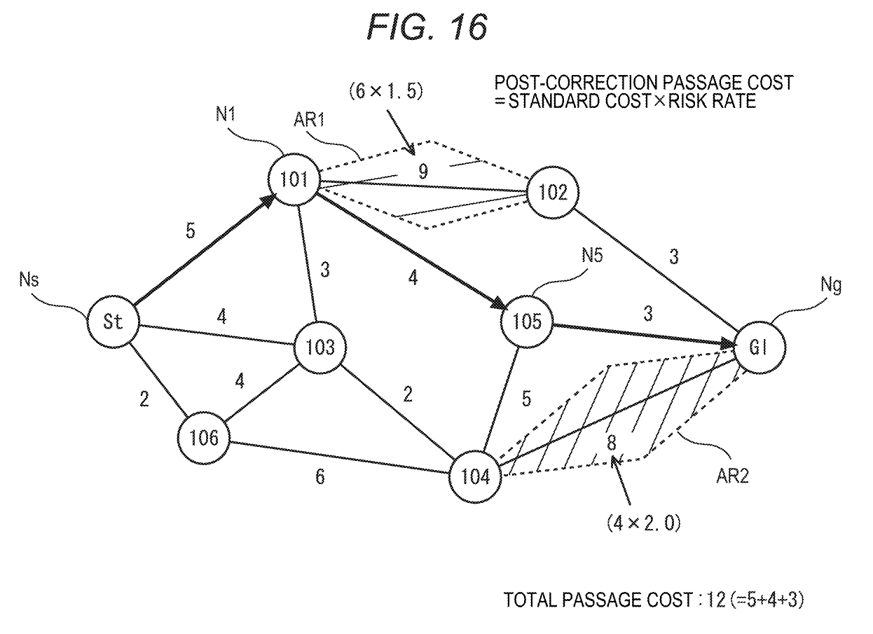

Comparative examples to be compared with the first embodiment will be described here with reference to FIGS. 15 and 16.

FIG. 15 is an example of generation of the route information according to a first comparative example. FIG. 16 is an example of generation of the route information according to a second comparative example. First, as illustrated in FIG. 15, when the route information is generated by the route generating part 115 using the standard cost without correction and the Dijkstra method, the route generating part 115 generates route information passing through the nodes Ns, N3, N4, and Ng, in which the minimum value “10” of the total passage cost is calculated. This is because, when the risk areas AR 1 and AR2 do not exist in the travel route from the departure point to the destination specified by the link information, the route generating part 115 generates route information different from the route information according to the working example.

Meanwhile, as illustrated in FIG. 16, when the route information is generated by the route generating part 115 using the standard cost that has been corrected with the risk rate and the Dijkstra method without using the risk tolerance score, the route generating part 115 generates route information passing through the nodes Ns, N1, N5, and Ng, in which the minimum value “12” of the total passage cost is calculated. This is because, when the standard cost “6” of the risk area AR1 is corrected to the post-correction passage cost “9” with the risk rate “1.5”, and the standard cost “4” of the risk area AR2 is corrected to the post-correction passage cost “8” with the risk rate “2.0”, the route generating part 115 generates route information different from both of the route information according to the working example and the route information according to the first comparative example.

In this manner, not only taking into consideration the risk areas AR1 and AR2 with latent risks but also taking into consideration the risk tolerance against the latent risks, the possibility that the travel route in the risk areas AR1 and AR2 is allowed to be passed through increases. For example, a travel route difficult to drive safely is no longer excluded.

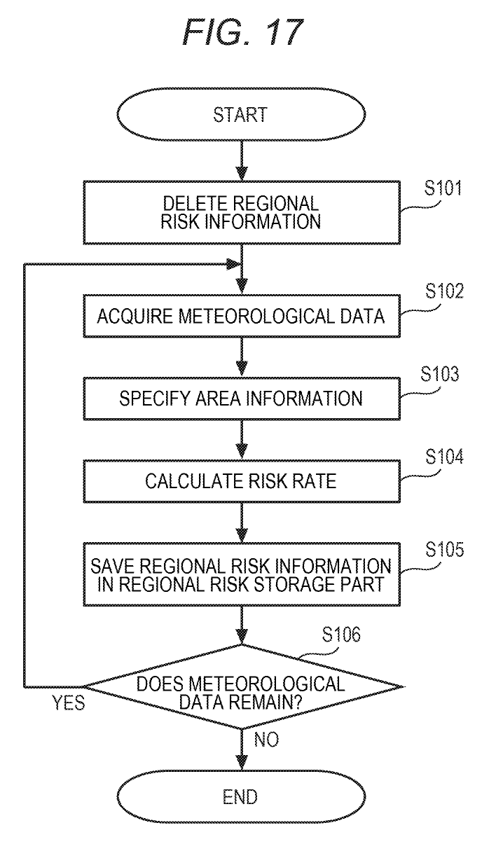

Subsequently, the action of the in-vehicle device 100 will be described with reference to FIGS. 17 to 19.

FIG. 17 is a flowchart illustrating an example of the action of the in-vehicle device 100. In more detail, FIG. 17 is a flowchart illustrating an example of the action of the meteorological risk updating part 105B. Since the respective actions of the traffic risk updating part 105C and the population risk updating part 105D are similar to the action of the meteorological risk updating part 105B, description thereof will be omitted.

First, the meteorological risk updating part 105B deletes regional risk information to be updated, from the regional risk storage part 106 (step S101). For example, when the control part 105A activates the meteorological risk updating part 105B, the meteorological risk updating part 105B deletes the regional risk information relating to the meteorology. With this process, the past regional risk information relating to the meteorology which remains in the regional risk storage part 106 disappears.

Upon completion of the process in step S101, the meteorological risk updating part 105B then acquires meteorological data (step S102). In more detail, the meteorological risk updating part 105B acquires one piece of meteorological data including a predetermined weather (for example, a weather “rainy weather”) from the meteorological information server 210. Upon acquiring the meteorological data, the meteorological risk updating part 105B generates a risk ID and generates regional risk information including the generated risk ID and the risk classification. For example, when the meteorological risk updating part 105B generates the risk ID “1”, the meteorological risk updating part 105B generates regional risk information including the risk ID “1” and the risk classification “meteorology” indicating that the risk is related to the meteorology.

Upon completion of the process in step S102, the meteorological risk updating part 105B then specifies area information from the acquired meteorological data (step S103). After specifying the area information, the meteorological risk updating part 105B saves the specified area information in an area information column of the regional risk information. When having finished specifying the area information, the meteorological risk updating part 105B specifies measurement time from the acquired meteorological data and saves the specified measurement time and a predetermined character string (for example, a character string “ongoing”) in a risk start time column and a risk end time column of the regional risk information, respectively.

Upon completion of the process in step S103, the meteorological risk updating part 105B then calculates the risk rate on the basis of data relating to the precipitation amount in the acquired meteorological data (step S104). After calculating the risk rate, the meteorological risk updating part 105B saves the calculated risk rate in a risk rate column of the regional risk information.

Upon completion of the process in step S104, the meteorological risk updating part 105B then saves the regional risk information (step S105). With this procedure, the regional risk storage part 106 stores the regional risk information relating to the risk classification “meteorology” (refer to FIG. 9).

Upon completion of the process in step S105, the meteorological risk updating part 105B then accesses the meteorological information server 210 to determine whether or not the meteorological data remains (step S106). When the meteorological data remains (step S105: YES), the meteorological risk updating part 105B repeats the processes from step S102 to S105. On the other hand, when the meteorological data does not remain (step S105: NO), the meteorological risk updating part 105B finishes the process. With this procedure, the regional risk information relating to the risk classification “meteorology” is accumulated in the regional risk storage part 106.

Since the traffic risk updating part 105C and the population risk updating part 105D also work in the same manner as the meteorological risk updating part 105B as described at the beginning, the regional risk storage part 106 stores respective pieces of the regional risk information relating to the risk classifications “traffic concentration” and “dense population”. Consequently, respective pieces of the regional risk information relating to “traffic concentration” and “dense population” are accumulated in the regional risk storage part 106.

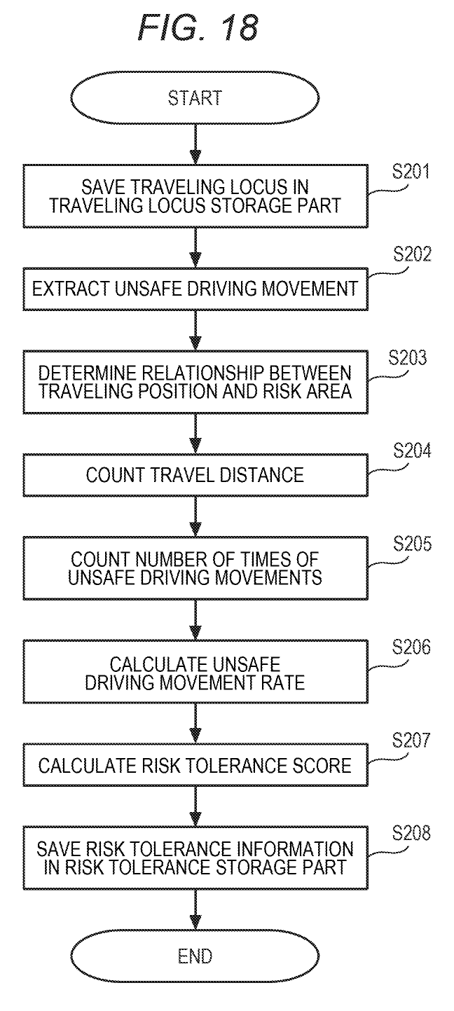

FIG. 18 is a flowchart illustrating another example of the action of the in-vehicle device 100. In more detail, FIG. 18 is a flowchart illustrating an example of actions of the traveling locus collecting part 103, the travel distance counting part 108, the unsafe driving extracting part 109, the unsafe driving counting part 110, and the risk tolerance calculating part 111.

When the vehicle CR starts traveling from the departure point, the traveling locus collecting part 103 saves the traveling locus information in the traveling locus storage part 104 (step S201). Thereafter, when the vehicle CR reaches the destination, the unsafe driving extracting part 109 acquires the traveling locus information from the traveling locus storage part 104 and extracts the unsafe driving movement on the basis of the acquired traveling locus information (step S202). The unsafe driving extracting part 109 extracts the position where the unsafe driving movement occurred, concurrently with the extraction of the unsafe driving movement.

Upon completion of the process in step S202, the travel distance counting part 108 then determines the relationship between the traveling position and the risk area (step S203). In more detail, the travel distance counting part 108 acquires the traveling locus information from the traveling locus storage part 104 and acquires the regional risk information from the regional risk storage part 106. The travel distance counting part 108 collates the traveling position included in the acquired traveling locus information with the area information included in the regional risk information to determine which risk area the traveling position overlaps.

For example, when a risk area has the area type “circle type”, whether or not the traveling position overlaps the risk area may be confirmed by following computation formula (1).

d=r·cos⁻¹(sin y2 sin cy+cos y2 cos cy cos(cx−x2)) (1)

In computation formula (1), the elements x2 and y2 represent the longitude and latitude of the center of the risk area, respectively. The elements cx and cy represent the longitude and latitude of the traveling position of the vehicle CR, respectively. The element r represents the equatorial radius of the earth. The element d represents the distance from the center of the risk area to the traveling position. When the distance d calculated by computation formula (1) is equal to or less than the radius r that specifies the risk area, it is determined that the element cx and cy are included in the risk area. When the risk area has an area type “multiple polygon type”, it may be inferred, for example, by the area inside/outside determination method disclosed in Japanese Laid-open Patent Publication No. 11-144041.

Upon completion of the process in step S203, the travel distance counting part 108 then counts the travel distance (step S204). In more detail, when determining that the traveling position overlaps a risk area, the travel distance counting part 108 confirms the risk classification of the risk area and counts the travel distance for each risk classification. In addition, also when the non-risk area not included in any risk classification is traveled, the travel distance counting part 108 counts the travel distance without risk. Instead of counting the travel distance, the travel distance counting part 108 may count the travel time.

Upon completion of the process in step S204, the unsafe driving counting part 110 then counts the number of times of unsafe driving movements (step S205). In more detail, the unsafe driving counting part 110 collates the position extracted by the unsafe driving extracting part 109 with the area information included in the regional risk information to determine whether or not the collated position overlaps the risk area. When determining that the collated position overlaps the risk area, the unsafe driving counting part 110 confirms the risk classification of the overlapping risk area and counts the number of times for each risk classification. In addition, also when an unsafe driving movement has occurred in the non-risk area not included in any risk classification, the unsafe driving counting part 110 counts the number of times without risk.

Upon completion of the process in step S205, the risk tolerance calculating part 111 then calculates the unsafe driving movement rate (step S206). In more detail, the risk tolerance calculating part 111 calculates the unsafe driving movement rate for each risk classification on the basis of a past counting result stored in the risk tolerance storage part 112, the travel distance counted by the travel distance counting part 108, and the number of times counted by the unsafe driving counting part 110.

Upon completion of the process in step S206, the risk tolerance calculating part 111 then calculates the risk tolerance score (step S207). In more detail, the risk tolerance calculating part 111 calculates the risk tolerance score for each risk classification on the basis of the unsafe driving movement rate for each risk classification calculated in the process in step S206. Upon completion of the process in step S207, the risk tolerance calculating part 111 saves the risk tolerance information including the travel distance, the number of times, the unsafe driving movement rate, and the risk tolerance score for each risk classification in the risk tolerance storage part 112 (step S208).

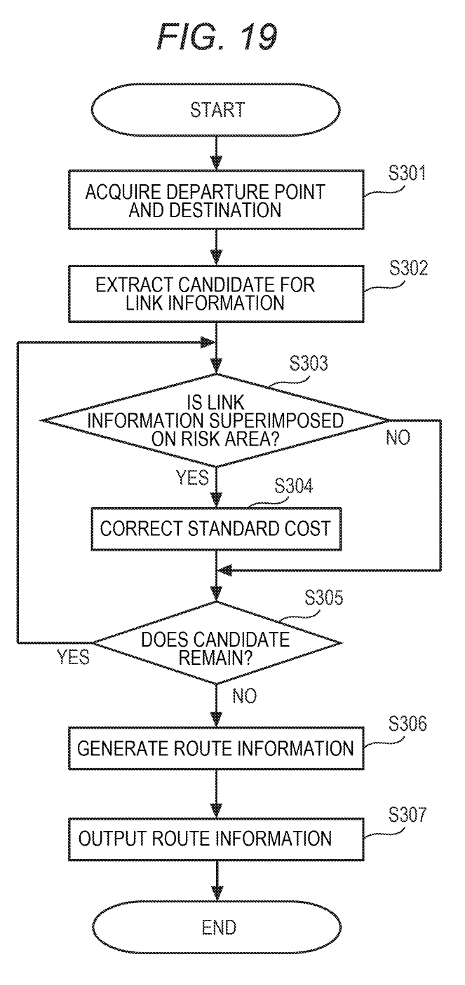

FIG. 19 is a flowchart illustrating another example of the action of the in-vehicle device 100. In more detail, FIG. 19 is a flowchart illustrating an example of actions of the input/output part 101, the point acquiring part 102, the cost correcting part 114, and the route generating part 115. The flowchart illustrated in FIG. 19 is executed at a traveling opportunity after the flowchart described with reference to FIG. 18.

First, when the driver performs an input operation for inputting a departure point and a destination on the input/output part 101, the point acquiring part 102 acquires the departure point and the destination from the input/output part 101 (step S301). Upon completion of the process in step S301, the cost correcting part 114 then extracts a candidate for the link information from the route map storage part 113 on the basis of the departure point and the destination acquired by the point acquiring part 102 (step S302).

Upon completion of the process instep S302, the cost correcting part 114 then determines whether or not the link information is superimposed on the risk area (step S303). In more detail, it is determined whether or not the longitude and latitude of two nodes specified by the link information are superimposed on the area information specifying the risk area (also refer to FIG. 14).

When the link information is superimposed on the risk area (step S303: YES), the cost correcting part 114 corrects the standard cost (step S304). In more detail, the cost correcting part 114 corrects the standard cost on the basis of the risk rate of the risk area and the risk tolerance score of the driver against the same risk area. On the other hand, when the link information is not superimposed on the risk area (step S303: NO), the cost correcting part 114 skips the process in step S304.

Upon completion of the process in step S304 or once the process in step S304 is skipped, the cost correcting part 114 then determines whether or not a candidate for the link information remains (step S305). When a candidate for the link information remains (step S305: YES), the cost correcting part 114 repeats the processes in steps S303 and S304. For example, as long as a candidate for the link information remains and the link information of the candidate is superimposed on the risk area, the cost correcting part 114 corrects the standard cost.

On the other hand, when a candidate for the link information does not remain (step S305: NO), the route generating part 115 generates route information (step S306). For example, the route generating part 115 generates route information from the departure point to the destination on the basis of the link information whose standard cost has been corrected. With this procedure, the route information in consideration of the risk tolerance of the driver is generated. Upon completion of the process in step S306, the input/output part 101 then outputs the route information generated by the route generating part 115 (step S307). Consequently, the driver is allowed to visually recognize the travel route from the departure point to the destination.

As described thus far, according to the first embodiment, the in-vehicle device 100 includes the traveling locus storage part 104, the regional risk storage part 106, and the travel distance counting part 108, the unsafe driving counting part 110, the risk tolerance calculating part 111, and the cost correcting part 114 as processing parts. The traveling locus storage part 104 stores the traveling locus information representing the traveling locus of the vehicle CR. The regional risk storage part 106 stores the regional risk information latent in a specific area. The travel distance counting part 108 counts the distance traveled by the vehicle CR on a route included in the specific area. The unsafe driving counting part 110 counts the number of times of unsafe driving movements taken by the vehicle CR while traveling on the route in the specific area. The risk tolerance calculating part 111 calculates the risk tolerance of the driver against the risk on the basis of the distance counted by the travel distance counting part 108 and the number of times counted by the unsafe driving counting part 110. The cost correcting part 114 corrects the standard cost between two nodes on a route using the risk and the risk tolerance. With this procedure, exclusion of a route in the risk area difficult to drive safely is preferably suppressed.

### Second Embodiment

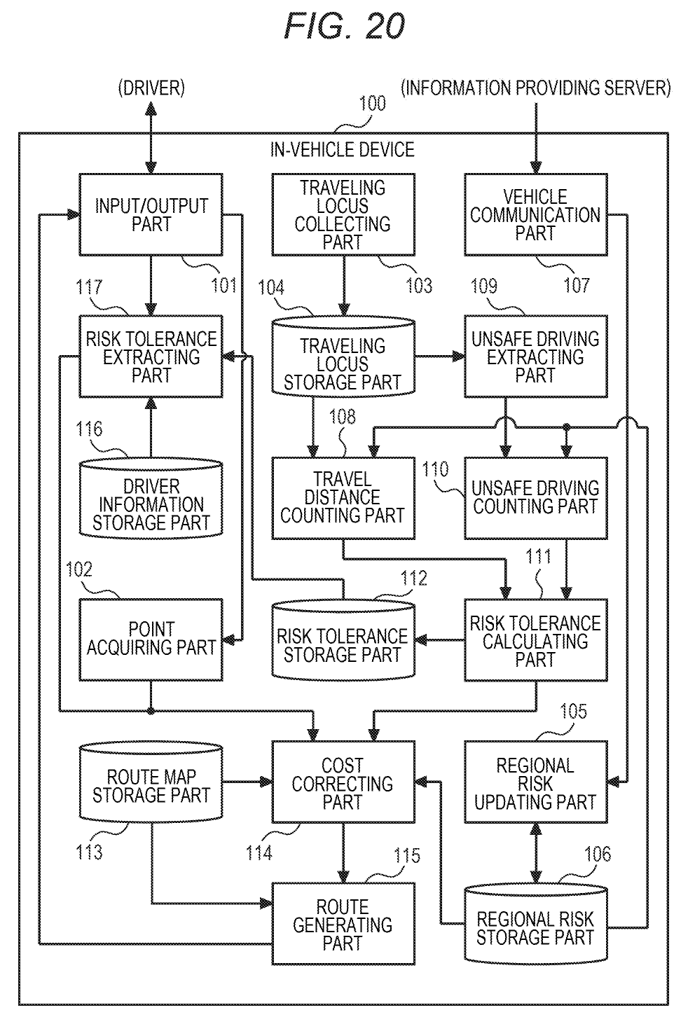

Subsequently, a second embodiment of the present invention will be described with reference to FIG. 20.

FIG. 20 is a functional block diagram of an in-vehicle device 100 according to the second embodiment. Components similar to respective parts of the in-vehicle device 100 illustrated in FIG. 3 are denoted by the same reference numerals and description thereof will be omitted. This also applies to embodiments to be described later. The in-vehicle device 100 according to the second embodiment is different from the in-vehicle device 100 according to the first embodiment in that the in-vehicle device 100 according to the second embodiment further includes a driver information storage part 116 and a risk tolerance extracting part 117.

The driver information storage part 116 stores driver information in which the characteristics of the driver are associated with the risk tolerance score of the same driver. For example, the risk tolerance score has already been calculated for the driver specified by the driver information. The characteristics of the driver include, for example, the driver's driving history, age, gender, and residential area.

Upon accepting a characteristic relating to a driver (for example, a new driver) not specified by the above-mentioned driver information from an input/output part 101, the risk tolerance extracting part 117 extracts a risk tolerance score according to the characteristic from a risk tolerance storage part 112. After extracting the risk tolerance score, the risk tolerance extracting part 117 transmits the extracted risk tolerance score to a cost correcting part 114. When the cost correcting part 114 uses the risk tolerance score included in the driver information of the existing driver whose characteristics resemble those of the new driver, a risk tolerance calculating part 111 does not have to calculate the risk tolerance score especially for the new driver. Therefore, for example, when the residential area of the new driver is a residential area with a large amount of snowfall, the risk tolerance extracting part 117 estimates the risk tolerance score of an existing driver whose residential area resembles the residential area of the new driver such that the cost correcting part 114 is allowed to use the risk tolerance score estimated by the risk tolerance extracting part 117.

### Third Embodiment

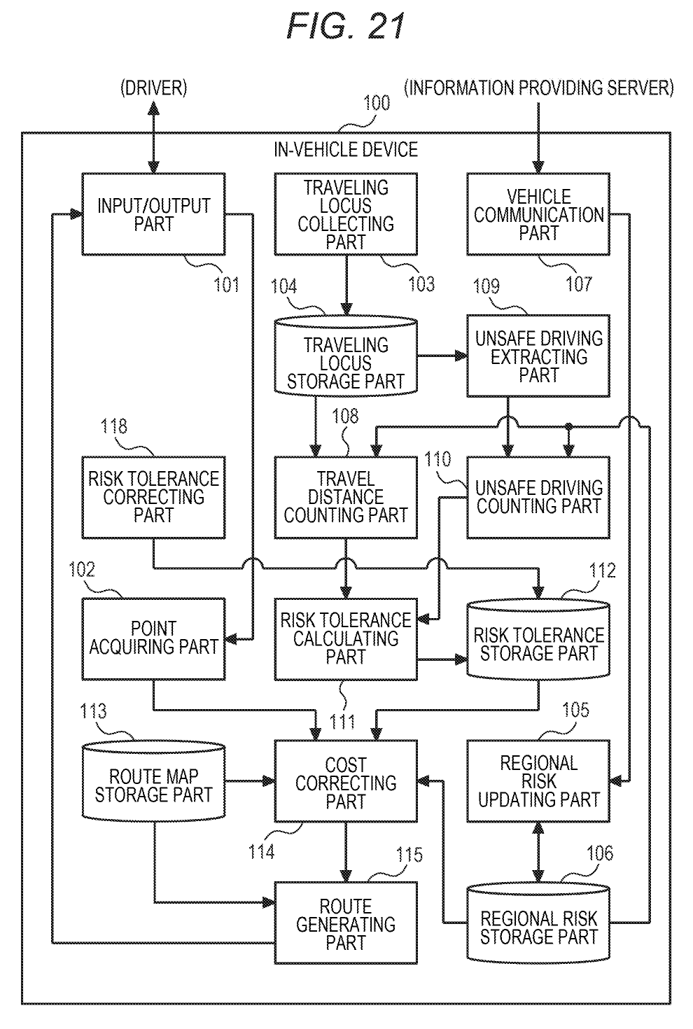

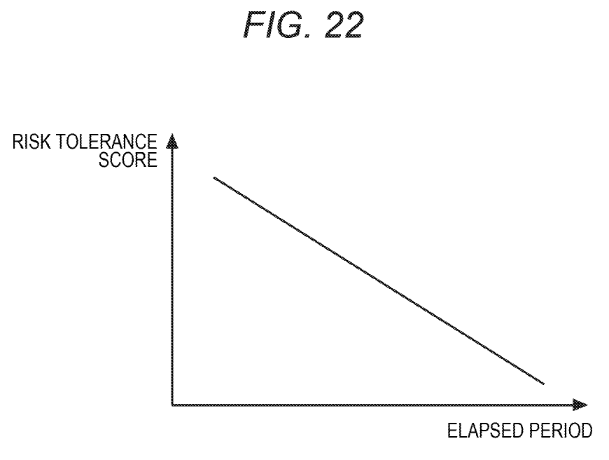

Subsequently, a third embodiment of the present invention will be described with reference to FIGS. 21 and 22.

FIG. 21 is a functional block diagram of an in-vehicle device 100 according to the third embodiment. FIG. 22 is a graph illustrating the relationship between elapsed time and the risk tolerance. As illustrated in FIG. 21, the in-vehicle device 100 according to the third embodiment is different from the in-vehicle device 100 according to the first embodiment in that the in-vehicle device 100 according to the third embodiment further includes a risk tolerance correcting part 118. A risk tolerance storage part 112 according to the third embodiment is also different from the risk tolerance storage part 112 according to the first embodiment in that the risk tolerance information includes update date and time.

The risk tolerance correcting part 118 corrects the risk tolerance score in the risk tolerance information stored in the risk tolerance storage part 112. For example, the risk tolerance correcting part 118 periodically refers to the update date and time of the risk tolerance information and, when determining that the update date and time has not been updated over a predetermined period, the risk tolerance correcting part 118 executes correction to lower the risk tolerance score stepwise. For example, as illustrated in FIG. 22, as the period elapses from the update date and time, the risk tolerance score declines. A cost correcting part 114 corrects the standard cost on the basis of the declined risk tolerance score. With this process, a route generating part 115 is allowed to generate route information with higher accuracy than in the first embodiment.

### Fourth Embodiment

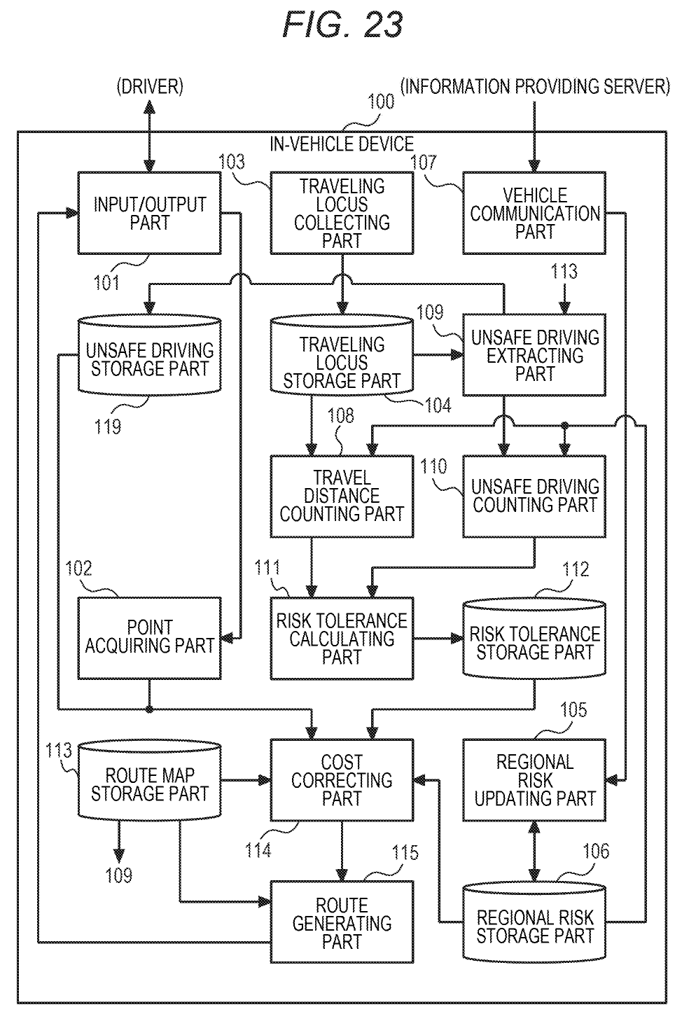

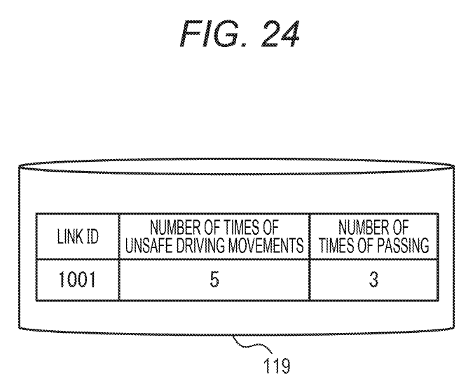

Subsequently, a fourth embodiment of the present invention will be described with reference to FIGS. 23 and 24.

FIG. 23 is a functional block diagram of an in-vehicle device 100 according to the fourth embodiment. FIG. 24 is an example of an unsafe driving storage part 119. The in-vehicle device 100 according to the fourth embodiment is different from the in-vehicle device 100 according to the first embodiment in that the in-vehicle device 100 according to the fourth embodiment further includes the unsafe driving storage part 119.

As illustrated in FIG. 24, the unsafe driving storage part 119 associates the number of times of the occurrence of unsafe driving movements that have occurred between nodes specified by the link information with the number of times of passing between the nodes together with the link ID to store as unsafe driving information. In more detail, when the unsafe driving extracting part 109 extracts an unsafe driving movement, the link information in the route map information stored in a route map storage part 113 is confirmed and the number of times of the occurrence of unsafe driving movements, the number of times of passing, and the link ID are saved in the unsafe driving storage part 119 as the unsafe driving information.

A cost correcting part 114 corrects the standard cost with reference to the unsafe driving storage part 119. In more detail, the unsafe driving storage part 119 calculates a correction coefficient on the basis of the number of times of unsafe driving movements, the number of times of passing, and predetermined computation formula (2) described below, and the cost correcting part 114 further corrects the standard cost after correction using the calculated correction coefficient.

Correction coefficient=number of times of unsafe driving movements/number of times of passing (2)

With this procedure, an unsafe driving movement that is likely to occur between nodes is taken into consideration and the standard cost after correction is further corrected. As a result, a route generating part 115 is allowed to generate route information with higher accuracy than in the first embodiment.

### Fifth Embodiment

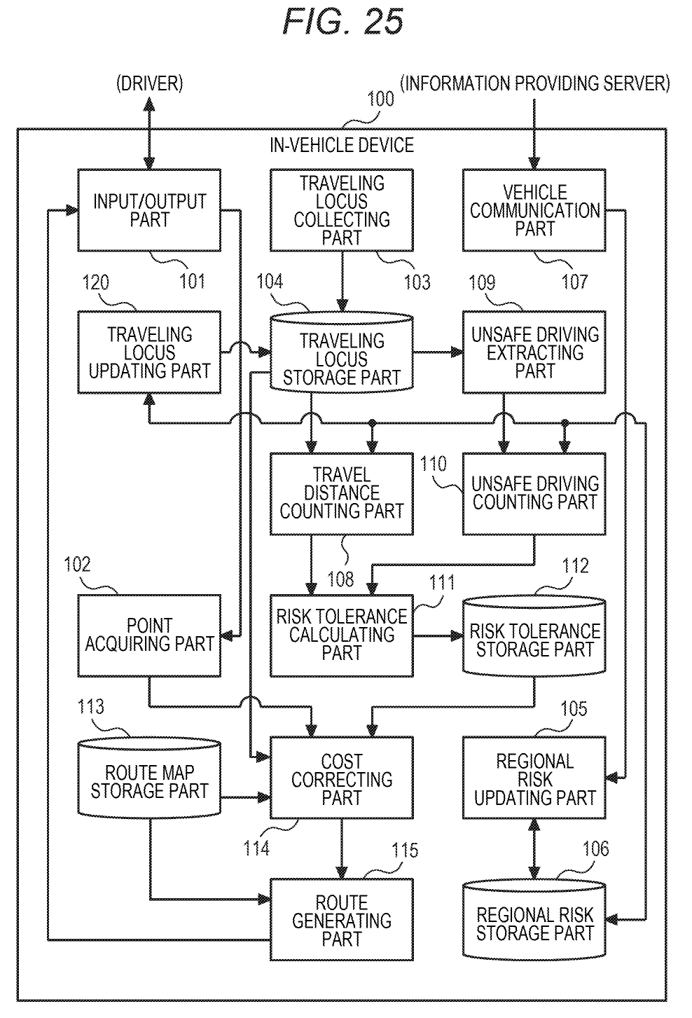

Subsequently, a fifth embodiment of the present invention will be described with reference to FIG. 25.

FIG. 25 is a functional block diagram of an in-vehicle device 100 according to the fifth embodiment. The in-vehicle device 100 according to the fifth embodiment is different from the in-vehicle device 100 according to the first embodiment in that the in-vehicle device 100 according to the fifth embodiment further includes a traveling locus updating part 120.

While the vehicle CR is traveling, the traveling locus updating part 120 updates the traveling locus information stored in a traveling locus storage part 104. In addition, the traveling locus updating part 120 extracts regional risk information according to the traveling position of the vehicle CR from a regional risk storage part 106 and saves the extracted regional risk information in the traveling locus storage part 104.

With this procedure, when a cost correcting part 114 corrects the standard cost, the standard cost may be corrected using the risk rate in the regional risk information stored in the traveling locus storage part 104. Therefore, past regional risk information that is less likely to be used is preferably deleted from the regional risk storage part 106 and the amount of information stored in the in-vehicle device 100 may be decreased.

### Sixth Embodiment

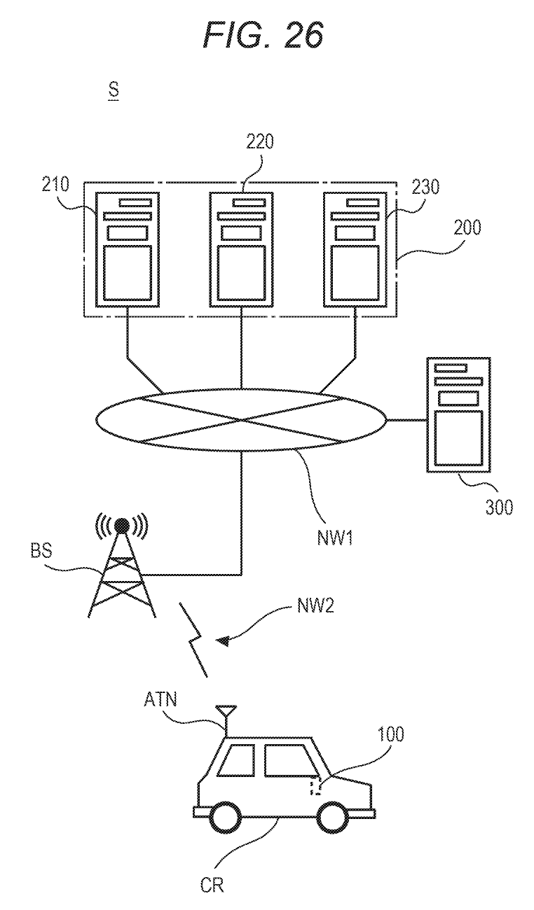

Subsequently, a sixth embodiment of the present invention will be described with reference to FIGS. 26 to 29.

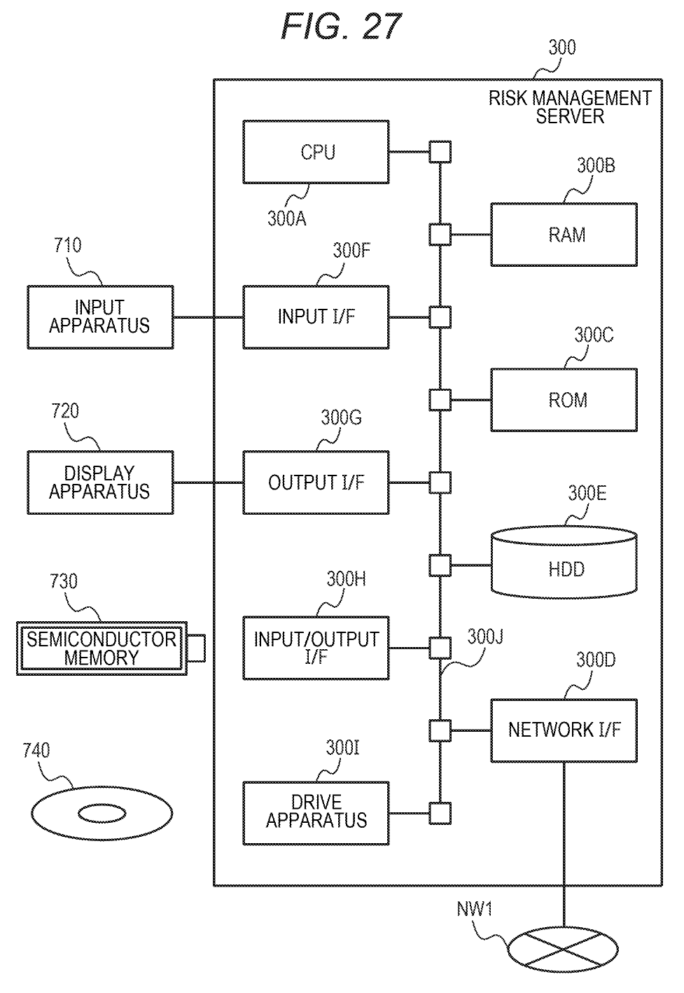

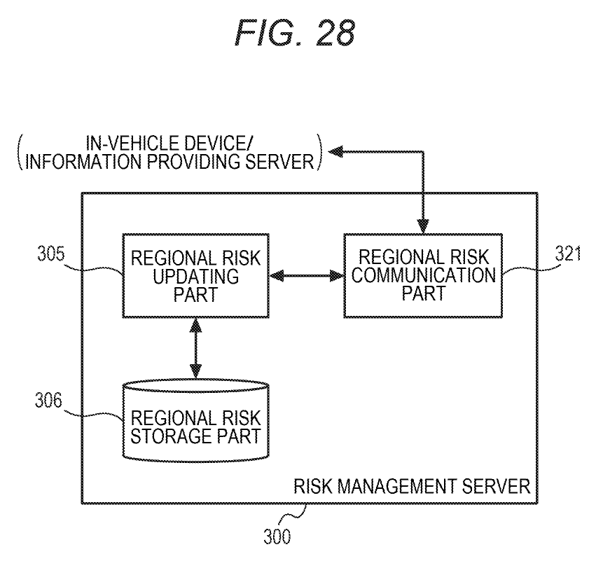

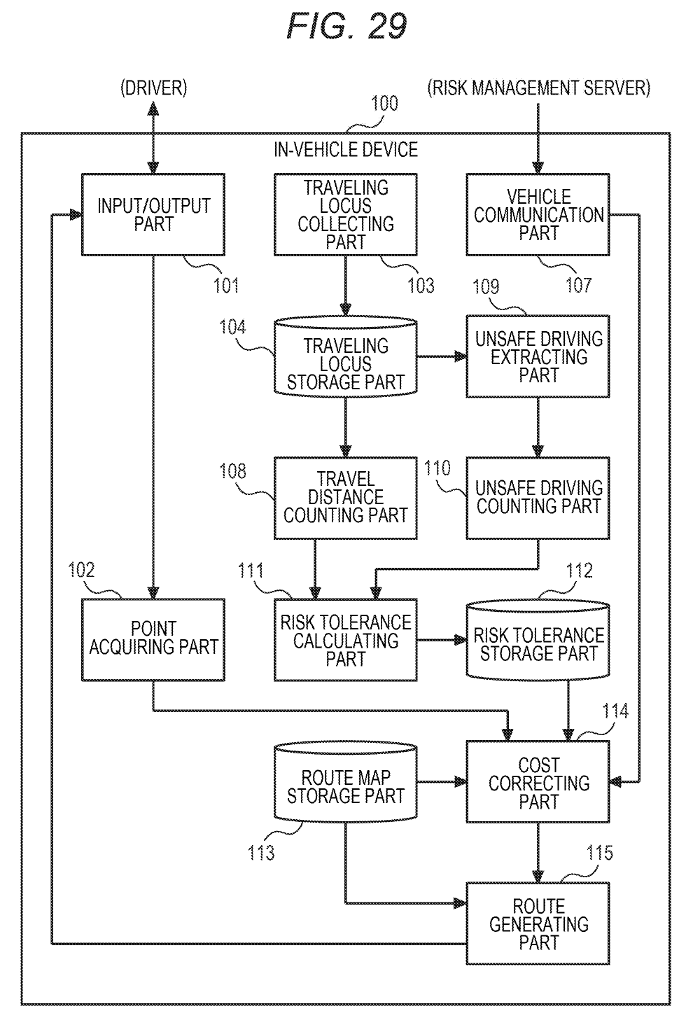

FIG. 26 is an example of a route information providing system S according to a sixth embodiment. FIG. 27 is an example of a hardware configuration of a risk management server 300. FIG. 28 is an example of a functional block diagram of the risk management server 300. FIG. 29 is a functional block diagram of an in-vehicle device 100 according to the sixth embodiment. The route information providing system S according to the sixth embodiment is different from the route information providing system S according to the first embodiment in that the route information providing system S according to the sixth embodiment further includes the risk management server 300.

As illustrated in FIG. 27, the risk management server 300 includes at least a CPU 300A, a RAM 300B, a ROM 300C, and a network I/F 300D. The risk management server 300 may include at least one of a hard disk drive (HDD) 300E, an input I/F 300F, an output I/F 300G, an input/output I/F 300H, and a drive apparatus 3001 as needed. The CPU 300A to the drive apparatus 3001 are connected to each other by an internal bus 300J. At least the CPU 300A and the RAM 300B cooperate to implement a computer.

An input apparatus 710 is connected to the input I/F 300F. Examples of the input apparatus 710 include a keyboard and a mouse.

A display apparatus 720 is connected to the output I/F 300G. Examples of the display apparatus 720 include a liquid crystal display.

A semiconductor memory 730 is connected to the input/output I/F 300H. Examples of the semiconductor memory 730 include a universal serial bus (USB) memory and a flash memory. The input/output I/F 300H reads a program and data stored in the semiconductor memory 730.

The input I/F 300F and the input/output I/F 300H have, for example, USB ports. The output I/F 300G has, for example, a display port.

A portable recording medium 740 is inserted into the drive apparatus 3001. Examples of the portable recording medium 740 include a removable disk such as a compact disc (CD)-ROM and a digital versatile disc (DVD). The drive apparatus 3001 reads a program and data recorded in the portable recording medium 740.

The network I/F 300D includes, for example, a port and a physical layer chip (PHY chip). The risk management server 300 is connected to a wired communication network NW1 via the network I/F 300D.

Programs stored in the ROM 300C and the HDD 300E are saved in the RAM 300B described above by the CPU 300A. A program recorded in the portable recording medium 740 is saved in the RAM 300B by the CPU 300A. By executing the saved programs by the CPU 300A, the risk management server 300 implements various functions to be described later. The meteorological information server 210, the traffic information server 220, and the population information server 230 described in the first embodiment also basically have the same configurations as the configuration of the risk management server 300.

The risk management server 300 manages the regional risk information described in the first to fifth embodiments. As illustrated in FIG. 28, the risk management server 300 includes a regional risk updating part 305, a regional risk storage part 306, and a regional risk communication part 321. Since the regional risk updating part 305 and the regional risk storage part 306 have the same configurations as the configurations of the regional risk updating part 105 and the regional risk storage part 106 of the in-vehicle device 100, corresponding reference numerals are given. Therefore, a detailed description of the regional risk updating part 305 and the regional risk storage part 306 will be omitted.

The regional risk updating part 305 acquires various types of data from an information providing server 200 via the regional risk communication part 321. For example, the regional risk updating part 305 acquires meteorological data from a meteorological information server 210. The regional risk updating part 305 acquires traffic data from a traffic information server 220. The regional risk updating part 305 acquires population density data from a population information server 230. Upon acquiring various types of data from the information providing server 200, the regional risk updating part 305 updates the regional risk storage part 306 on the basis of various types of data.

Meanwhile, as illustrated in FIG. 29, the in-vehicle device 100 according to the sixth embodiment is configured by removing the regional risk updating part 105 and the regional risk storage part 106 from the in-vehicle device 100 according to the first embodiment. Therefore, each of a travel distance counting part 108, an unsafe driving counting part 110, and a cost correcting part 114 acquires the regional risk information from the risk management server 300 via a vehicle communication part 107. For example, when the travel distance counting part 108, the unsafe driving counting part 110, and the cost correcting part 114 each request the risk management server 300 for the regional risk information, the regional risk updating part 305 extracts the regional risk information to transmit to the in-vehicle device 100 via the regional risk communication part 321.

In this manner, in the sixth embodiment, the risk management server 300 has a part of the functions included in the in-vehicle device 100, such that the configuration of the in-vehicle device 100 is suitably simplified. In addition, the processing load expected for the in-vehicle device 100 to update the regional risk information is also suitably reduced.

### Seventh Embodiment

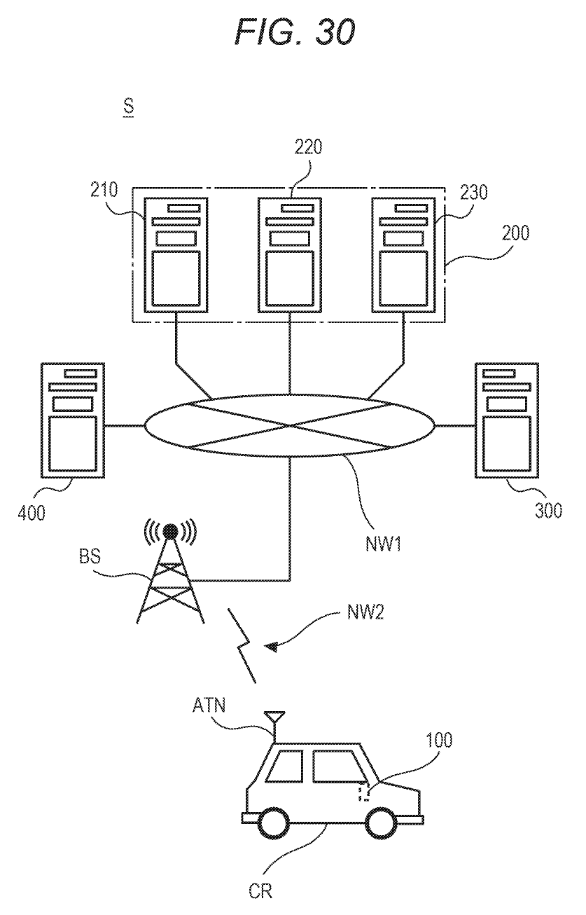

Subsequently, a seventh embodiment of the present invention will be described with reference to FIGS. 30 to 32.

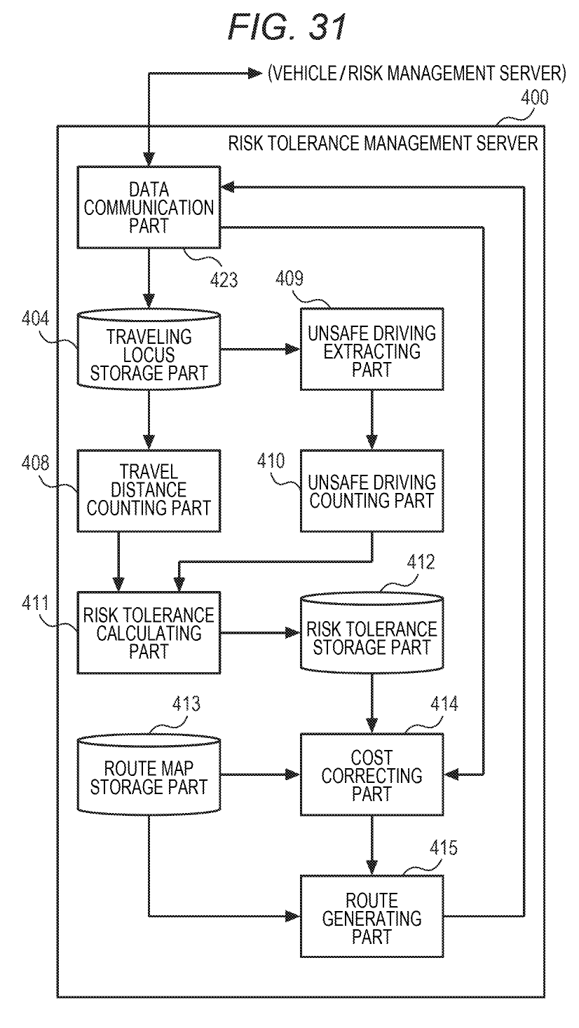

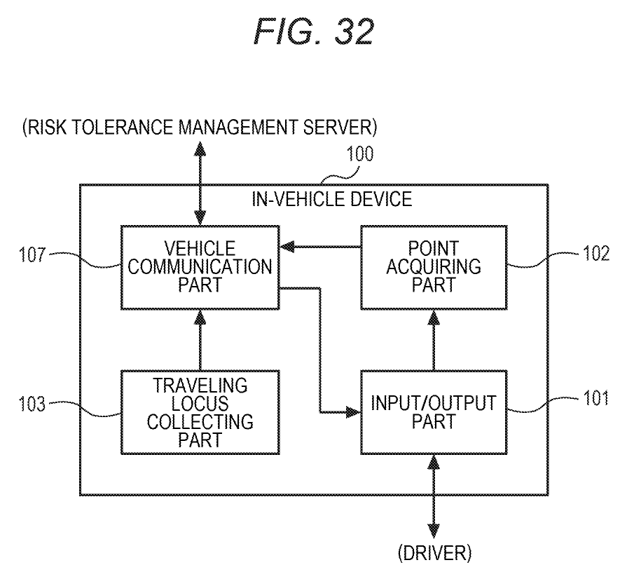

FIG. 30 is an example of a route information providing system S according to the seventh embodiment. FIG. 31 is an example of a functional block diagram of a risk tolerance management server 400. FIG. 32 is a functional block diagram of an in-vehicle device 100 according to the seventh embodiment. The route information providing system S according to the seventh embodiment is different from the route information providing system S according to the sixth embodiment in that the route information providing system S according to the seventh embodiment further includes the risk tolerance management server 400. Since the hardware configuration of the risk tolerance management server 400 is basically the same as the hardware configuration of the risk management server 300 described in the sixth embodiment, description thereof will be omitted.

The risk tolerance management server 400 as a route information providing apparatus manages the risk tolerance information described in the first to fifth embodiments. As illustrated in FIG. 31, the risk tolerance management server 400 includes a traveling locus storage part 404, a travel distance counting part 408, an unsafe driving extracting part 409, and an unsafe driving counting part 410. The risk tolerance management server 400 also includes a risk tolerance calculating part 411 and a risk tolerance storage part 412. The risk tolerance management server 400 further includes a route map storage part 413, a cost correcting part 414, a route generating part 415, and a data communication part 423.

Since each function included in the risk tolerance management server 400 has the same configuration as the configuration of each function included in the in-vehicle device 100, corresponding reference numerals are given. Therefore, a detailed description of each function included in the risk tolerance management server 400 will be omitted.

Meanwhile, as illustrated in FIG. 32, the in-vehicle device 100 according to the seventh embodiment includes an input/output part 101, a point acquiring part 102, a traveling locus collecting part 103, and a vehicle communication part 107. Therefore, the input/output part 101 acquires the route information from the risk tolerance management server 400 via the vehicle communication part 107. For example, when the driver performs an input operation for inputting a departure point and a destination on the input/output part 101, the point acquiring part 102 transmits the departure point and the destination to the risk tolerance management server 400 via the vehicle communication part 107. In addition, the traveling locus collecting part 103 transmits the collected traveling locus to the risk tolerance management server 400.

The risk tolerance management server 400 generates the route information on the basis of the departure point, the destination, and the traveling locus received from the in-vehicle device 100 via the data communication part 423 and the regional risk information received from a risk management server 300 via the data communication part 423. Upon generating the route information, the risk tolerance management server 400 transmits the generated route information to the in-vehicle device 100. In response to the transmission, the input/output part 101 of the in-vehicle device 100 outputs the route information.

In this manner, in the seventh embodiment, the risk tolerance management server 400 has a part of the functions included in the in-vehicle device 100, such that the configuration of the in-vehicle device 100 is suitably further simplified, as compared with the sixth embodiment. In addition, the processing load expected for the in-vehicle device 100 to calculate the risk tolerance information and the processing load expected for the in-vehicle device 100 to generate the route information are also suitably reduced. Furthermore, the maintenance at the time of administration of the route information providing system S is preferably concentrated on the server side.

Although the preferred embodiments of the present invention have been described in detail thus far, the present invention is not limited to specific embodiments according to the present invention and various modifications and alterations may be made within the scope of the present invention described in the claims. For example, each of the functions added to the in-vehicle device 100 of the first embodiment (for example, the risk tolerance extracting part 117 and the risk tolerance correcting part 118), which has been explained in and after the second embodiment, may be included in the risk tolerance management server 400 or may be included in a server other than the risk tolerance management server 400. In addition, each of the regional risk storage parts 106 and 306 and the risk tolerance storage parts 112 and 412 may be included in a different server from the in-vehicle device 100, the risk management server 300, and the risk tolerance management server 400. Furthermore, the configurations of the second to fifth embodiments may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing apparatus comprising:
a memory; and
a processor coupled to the memory and configured to:
refer to first information that indicates a traveling locus of a vehicle and second information that indicates a risk latent in an area;
count a distance which is traveled by the vehicle along a route included in the area and a number of times of unsafe driving movements which are taken by the vehicle while traveling on the route;
calculate risk tolerance of a driver against the risk on the basis of the counted distance and number of times; and
correct a passage cost between two points on a route using the risk and the risk tolerance.

2. The information processing apparatus according to claim 1, wherein the processor is configured to:
refer, when accepting a characteristic relating to another driver different from the driver, to third information that indicates driver information in which a characteristic of the driver is associated with the risk tolerance;
extract the risk tolerance of a driver whose characteristic resembles the characteristic of the another driver; and
correct the passage cost using the extracted risk tolerance.

3. The information processing apparatus according to claim 1, wherein the processor is configured to lower the risk tolerance when update of the risk tolerance is stagnated.

4. The information processing apparatus according to claim 1 wherein the processor is configured to:
refer to fourth information that indicates a number of times of occurrence of unsafe driving movements that are occurred between the two points and a number of times of passing between the two points in association with each other;
calculate a coefficient according to the number of times of occurrence and the number of times of passing; and
correct the passage cost after correction using the calculated coefficient.

5. The information processing apparatus according to claim 1, wherein the processor is configured to:
extract, each time the first information is updated while the vehicle is traveling or after traveling, the risk on the traveling locus from the second information; and
erase the risk stored in the second information.

6. The information processing apparatus according to claim 1, wherein the processor is configured to:
receive a traveling locus of a vehicle transmitted from an in-vehicle device that is a separate body from the information processing apparatus; and
store the traveling locus in the first information.

7. The information processing apparatus according to claim 1, wherein the processor is configured to generate route information on a route including the two points, using the corrected passage cost.

8. The information processing apparatus according to claim 1, wherein the processor is configured to acquire a departure point and a destination input based on an operation,
wherein the passage cost between two points located on a route from the acquired departure point to the acquired destination is corrected using the risk and the risk tolerance.

9. The information processing apparatus according to claim 8, wherein
the second information is provided in another apparatus that is a separate body from the information processing apparatus, and
the processor refers to the second information provided in the another apparatus.

10. A method, comprising:
executing, by a first computer provided in a vehicle, a process of transmitting a traveling locus of the vehicle; and
executing, by a second computer provided in another apparatus that is a separate body from the vehicle, a process of:
receiving the traveling locus to save as first information;
referring to the first information and second information that indicates a risk latent in a specific area;
counting a distance which is traveled by the vehicle along a route included in the specific area and a number of times of unsafe driving movements which is taken by the vehicle while traveling on the route;
calculating risk tolerance of a driver against the risk based on the counted distance and number of times; and
correcting a passage cost between two points on a route using the risk and the risk tolerance.

11. The method according to claim 10, further comprising:
referring to, when accepting a characteristic relating to another driver different from the driver, third information that indicates stores driver information in which a characteristic of the driver is associated with the risk tolerance;
extracting risk tolerance of a driver whose characteristic resembles the characteristic of the another driver; and
correcting the passage cost using the extracted risk tolerance.

12. The method according to claim 10, further comprising
lowering the risk tolerance when update of the risk tolerance is stagnated.

13. The method according to claim 10, further comprising:
referring to fourth information that indicates a number of times of occurrence of unsafe driving movements that are occurred between the two points and a number of times of passing between the two points in association with each other;
calculating a coefficient according to the number of times of occurrence and the number of times of passing; and
correcting the passage cost after correction using the calculated coefficient.

14. The method according to claim 10, further comprising:
extracting, each time the first information is updated while the vehicle is traveling or after traveling, a risk on the traveling locus from the second information; and
erasing the risk stored in the second information.

15. The method according to claim 10, further comprising:
receiving a traveling locus of a vehicle transmitted from an in-vehicle device that is a separate body from the another apparatus; and
storing the traveling locus in the first information.

16. The method according to claim 10, further comprising
generating route information on a route including the two points, using the corrected passage cost.
